(19) United States
(12) Patent Application Publication
(10) Pub. No.: US 2020/0111080 A1
(43) Pub. Date: Apr. 9, 2020

(54) Security Secret Interface and Token Wrap Structure Apparatuses, Methods and Systems

(71) Applicant: BitGo Holdings, Inc., Palo Alto, CA (US)

(72) Inventors: Christopher Scott Metcalfe, San Francisco, CA (US); Robert William Rutherford, Crown Point, IN (US); Daniel Kenneth Hoffmann, San Francisco, CA (US)

(21) Appl. No.: 16/596,656

(22) Filed: Oct. 8, 2019

Related U.S. Application Data
(60) Provisional application No. 62/911,963, filed on Oct. 7, 2019.
(60) Provisional application No. 62/742,877, filed on Oct. 8, 2018.

(51) Int. Cl. G06Q 20/36; H04L 9/32; H04L 9/08; G06Q 10/06; G06Q 20/38

(52) U.S. Cl. CPC G06Q 20/36; H04L 9/3255; H04L 9/0877; H04L 9/0894; G06Q 2220/00; G06Q 10/0633; G06Q 20/3821; G06Q 20/3829; H04L 2209/56; H04L 9/085

(57) ABSTRACT

The Security Secret Interface and Token Wrap Structure Apparatuses, Methods and Systems (“SSITWS”) transforms cryptographic assets, cryptographic asset addresses, user names, workflow names, workflow conditions, workflow access privileges, wallet conditions, wallet access privileges, transaction signing request inputs via SSITWS components into HSM partition, cryptographic shards, workflow access privileges, wallet access privileges, transaction signing response outputs. A workflow creation request datastructure associated with a cryptographic wallet datastructure is obtained. A selection of rules for accessing cryptographic assets associated with the cryptographic wallet datastructure, a selection of a minimum number of approval signatures, and a selection of signing groups are obtained. A set of asymmetric keys associated with the signing groups is generated. Access to an HSM partition associated with the cryptographic wallet datastructure is configured using the generated set of asymmetric keys. Asymmetric keys data for accessing the individual HSM partition is stored in encrypted security vault data structures.

### PRIORITY CLAIM

Applicant hereby claims benefit to priority under 35 USC § 119 as a non-provisional conversion of: U.S. provisional patent application Ser. No. 62/911,963, filed Oct. 7, 2019, entitled “Security Secret Interface and Token Wrap Structure Apparatuses, Methods and Systems”, (attorney docket no. BitGo0002PV); and U.S. provisional patent application Ser. No. 62/742,877, filed Oct. 8, 2018, entitled “Security Secret Interface and Token Wrap Structure Apparatuses, Methods and Systems”, (attorney docket no. Hedgly0001PV).

The entire contents of the aforementioned applications are herein expressly incorporated by reference.

This application for letters patent disclosure document describes inventive aspects that include various novel innovations (hereinafter “disclosure”) and contains material that is subject to copyright, mask work, and/or other intellectual property protection. The respective owners of such intellectual property have to objection to the facsimile reproduction of the disclosure by anyone as it appears in published Patent Office file/records, but otherwise reserve all rights.

### FIELD

The present innovations generally address security encryption and management, and more particularly, include Security Secret Interface and Token Wrap Structure Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

A hardware security module (HSM) is a computing device that is designed to protect digital cryptographic keys and plug into a computer.

### BRIEF DESCRIPTION OF THE DRAWINGS

Appendices and/or drawings illustrating various, non-limiting, example, innovative aspects of the Security Secret Interface and Token Wrap Structure Apparatuses, Methods and Systems (hereinafter “SSITWS”) disclosure, include:

FIGS. 1A-B show a datagraph illustrating data flow(s) for the SSITWS;

FIG. 2 shows a logic flow illustrating embodiments of a wallet creation (WAC) component for the SSITWS;

FIGS. 3A-C show a logic flow illustrating embodiments of a workflow creation (WOC) component for the SSITWS;

FIG. 4 shows a screenshot illustrating user interface(s) of the SSITWS;

FIG. 5 shows a screenshot illustrating user interface(s) of the SSITWS;

FIG. 6 shows a screenshot illustrating user interface(s) of the SSITWS;

FIGS. 7A-B show a screenshot illustrating user interface(s) of the SSITWS;

FIG. 8 shows a screenshot illustrating user interface(s) of the SSITWS;

FIGS. 9A-B show a datagraph illustrating data flow(s) for the SSITWS;

FIGS. 10A-C show a logic flow illustrating embodiments of a transaction signing (TS) component for the SSITWS;

FIGS. 11A-C show a datagraph illustrating data flow(s) for the SSITWS;

FIG. 12 shows a logic flow illustrating embodiments of a staking node provisioning (SNP) component for the SSITWS;

FIG. 13 shows a screenshot illustrating user interface(s) of the SSITWS;

FIG. 14 shows a screenshot illustrating user interface(s) of the SSITWS;

FIG. 15 shows a screenshot illustrating user interface(s) of the SSITWS;

FIG. 16 shows a screenshot illustrating user interface(s) of the SSITWS;

FIG. 17 shows a screenshot illustrating user interface(s) of the SSITWS;

FIG. 18 shows a screenshot illustrating user interface(s) of the SSITWS;

FIG. 19 shows a screenshot illustrating user interface(s) of the SSITWS;

FIG. 20 shows a block diagram illustrating embodiments of a SSITWS controller.

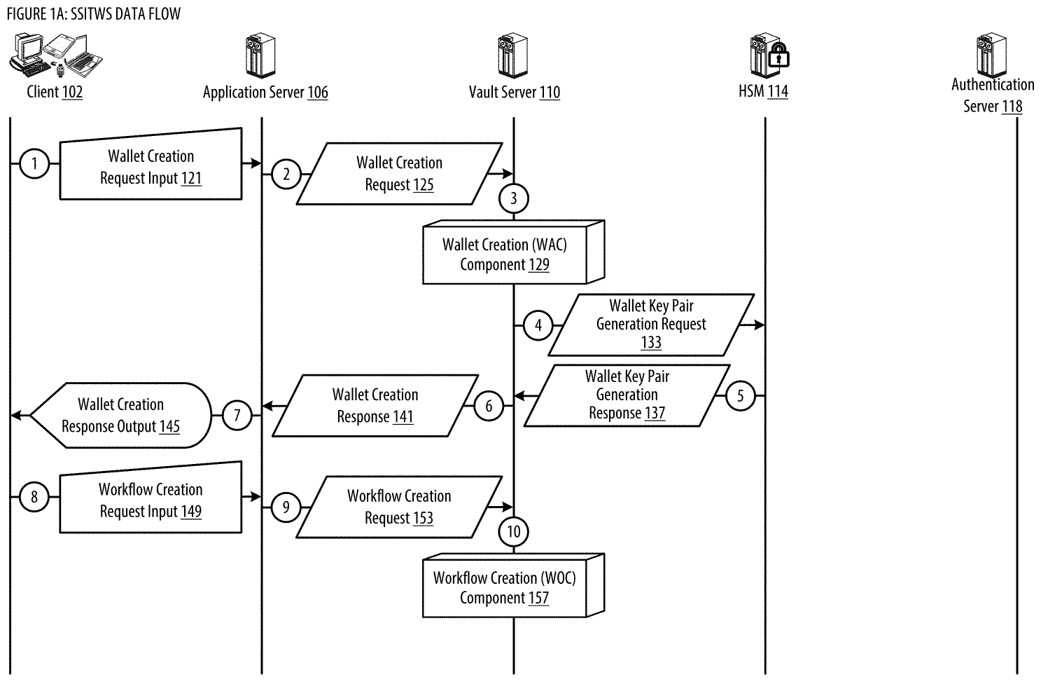

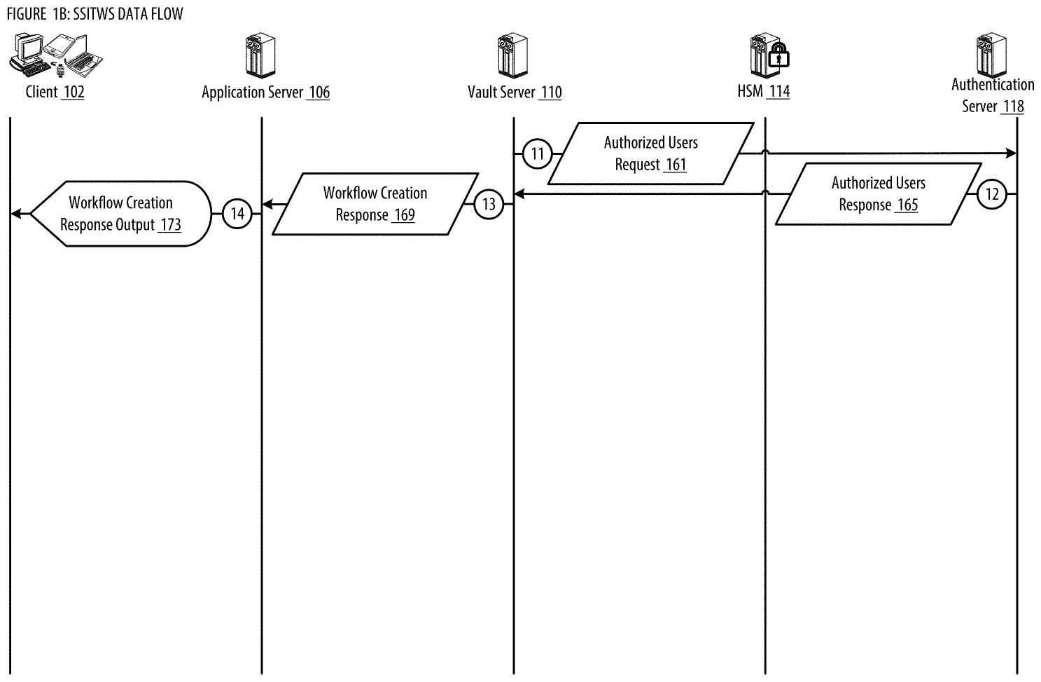

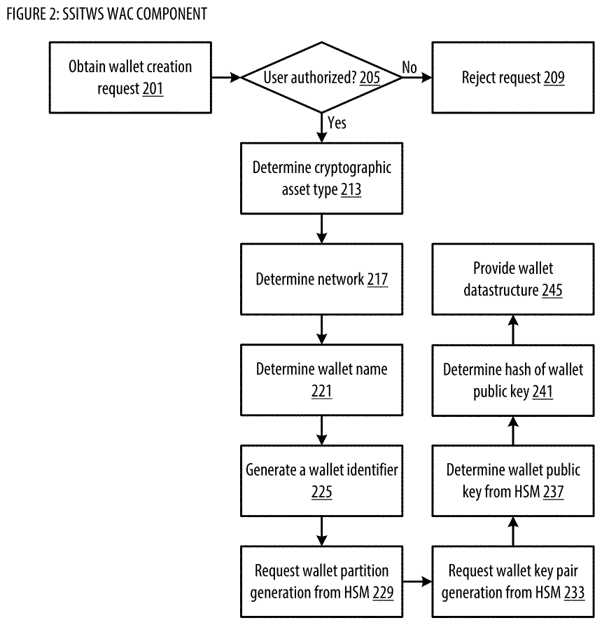

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Security Secret Interface and Token Wrap Structure Apparatuses, Methods and Systems (hereinafter “SSITWS”) transforms cryptographic assets, cryptographic asset addresses, user names, workflow names, workflow conditions, workflow access privileges, wallet conditions, wallet access privileges, transaction signing request inputs, via SSITWS components (e.g., WAC, WOC, TS, SNP, etc. components), into HSM partition, cryptographic shards, workflow access privileges, wallet access privileges, transaction signing response outputs. The SSITWS components, in various embodiments, implement advantageous features as set forth below.

### Introduction

The SSITWS provides unconventional features (e.g., provides a dedicated HSM security module for every individual crypto wallet and allows for roles and policy addressing that may be performed accessing an asymmetric key to ensure any processes on the HSM are performed securely) that were never before available in security encryption and management.

In one embodiment, the SSITWS platform is cloud based accessible to scalable, dedicated hardware security modules (HSM). As such, every individual crypto wallet on the SSITWS has its own HSM partition where it stores a private key to a crypto wallet. This provides never before available levels of security for a key wallet system. The SSITWS may then generate a different set of asymmetric keys for accessing the HSM. The SSITWS may store those in a cryptographic vault. The cryptographic vault may have a set of policies for accessing that asymmetric key. Whenever the policies requirements have been met, the SSITWS may then use the asymmetric key to perform processes on the HSM, such as submitting a transaction to be signed and broadcast to the network. As such, the SSITWS provides numerous benefits that were never before available, including:
Only Dedicated scalable HSM solution for every wallet (or omnibus structure) (thousands of HSM partitions per minute)
Cloud or on prem
Easy to set up workflow and rule-based management interface
Support for strong two factor authentication and third party HSM support
Token agnostic solution—use the same process and workflows for every token/currency.
API platform for white label integration.
Multiple, layers of security
Customizable cryptographic signature workflow (currently currencies only support m of n signature parameters)
Easy to use platform that allows those unfamiliar with blockchain to use best in class security and practices

There are numerous variations and implementations on how the SSITWS performs the above. In one embodiment, the SSITWS employs sharding the asymmetric key into multiple cryptographic vaults. In another embodiment, the SSITWS employs a quorum token from the HSM to create a multi-signature process off chain for blockchains that do not support multi-signature security. Alternatively, rather than sticking the asymmetric key in a cryptographic vault, the SSITWS may use another HSM, or an RSA token, etc. to generate and store the asymmetric key. In another embodiment, the SSITWS may use a password key and/or other authorization token that is sharded and/or encrypted instead of an Asym Key. As such, the SSITWS may operate even under conditions where an Asym key is not always introduced as the multi signature access control mechanism.

In another embodiment, the platform also may use multi-factor auth for all sign on, including hardened physical keys like a yubi key and authenticator apps like Authy.

The SSITWS also may employ architecture variations as well. In one embodiment, the SSITWS allows only a single bastion to log into any environment and destroying the root access token when that bastion is created. Then, the SSITWS sets up VPC peering across environments (e.g., staging, production, dev). Also, the SSITWS may include separate logging at every module and require SSH keys to access any environment.

SSITWS uses response wrapping tokens (auth token) to securely manage user groups' access to their Asymmetric Key (which is used to access/authenticate to HSM) is stored in the secret engine. It takes the coordinated actions (approval work flow) to gain access to the Asymmetric Key in the secrets engine and requires M of N Asymmetric Keys to approve any function on the HSM.
When a response is wrapped, the normal response from SSITWS does not contain the Asymmetric Key, but rather contains a set of information related to the response-wrapping token
The wrapped secret can be unwrapped using the single-use wrapping token. Even the system which created the Asymmetric Key won't see the original value.
The wrapping token is short-lived (expires daily) and can be revoked just like any other tokens so that the risk of unauthorized access is minimized.
No token can access another token's Secret Engine.
Of note: SSITWS encrypts data at rest using 256-bit AES in GCM mode with a randomly generated nonce prior to writing them to its persistent storage. The storage backend never sees the unencrypted value, so gaining access to the raw storage will never be enough to access any sensitive information.

Each user group has an asymmetric key for signing which is created using AWS Key Management System (KMS)
Each HSM user group is associated to the HSM and registers the public part of their signing key (the public key) with the HSM. (the private key is the AsymmetricKey discussed above)
When an SSITWS user wants to perform an operation they gain access to the Asymmetric Key as described above and propose a transaction to the HSM which returns a quorum token.
The quorum token is returned to SSITWS for one or more other user groups to provide their approval.
The other users groups approve by coordinating according to the work flow to gain access to the Asymmetric Key as described above which is used to cryptographically sign the quorum token.
When the SSITWS has the required number of approvals, transmit the quorum token and approvals (signatures) to the HSM.
The HSM uses the registered public keys of each signer to verify the signatures. If the signatures are valid, the HSM approves the token.
The HSM may now utilize the private key associated with the underlying crypto wallet.

In one embodiment, SSITWS may connect financial services companies to blockchain assets while providing scalable enterprise level custody facilities. The SSITWS provides such facilities by including blockchain asset solutions, security, protection against security threats, clearing execution and settlements, etc.

In one embodiment, SSITWS provides blockchain asset solutions that provide scalable enterprise level custody, including:
Each customer account has segregated and dedicated hardware and encrypted private keys never leave the hardware
Available funding 24/7
Facilities to easily create procedures and rules-based access for easy wallet management
FIPS 140-2, SOC 2, PII solutions, etc.

In one embodiment, SSITWS provides security to overcome threats when securing digital assets, including, physical risks (e.g., gunpoint, force, etc.), malicious insiders, third party risk, phishing attacks, human error (e.g., fat finger errors), loss of private keys, etc. SSITWS protects against such risks by providing full control of your private keys, hardware security modules, two-factor authentication, multi-tier/multi-level approaches, role and rule-based activity monitoring, key recovery services, etc. Also, the SSITWS may use hardware security modules (HSMs) to store private keys used to generate transaction signatures, so that they are always secure and never exposed. The SSITWS provides API services to build seamless custom integrations, and also provides a white-labeled user interface, allowing others to get up and running quickly and with no technical knowledge required. Multi-signature accounts are used, requiring many parties to coordinate to sign transactions. Additional keys can be stored with trusted third parties—used only to recover lost or compromised keys. In another embodiment, Shamir secret sharing maybe used for cryptographic sharing and distributing secrets to a number of users. Using this mechanism, the SSITWS may increase security by requiring many signatures to approve any action. Effectively enabling multisig-like functionality for any action, even on blockchains not offering multisig.

In one embodiment, SSITWS provides clearing, execution and settlement, including,
Execution—Proprietary bilateral system allows for guaranteed execution and liquidity.
Clearing—Clearing is done in near real time providing for fast user experiences and reporting.
Settlement—Daily settlement allows for on chain transfers and operational efficiencies when dealing with fiat transfers.

### SSITWS

FIGS. 1A-B show a datagraph illustrating data flow(s) for the SSITWS. In FIGS. 1A-B, a client 102 (e.g., of a user) may send a wallet creation request input 121 to an application server 106 (e.g., running a Rails app) to facilitate creating a cryptographic wallet (e.g., a Bitcoin wallet, an Ethereum wallet). For example, the client may be a desktop, a laptop, a tablet, a smartphone, a smartwatch, and/or the like that is executing a client application. In one implementation, the wallet creation request input may include data such as a request identifier, a wallet name, an account key, an asset type, a network name, and/or the like. In one embodiment, the client may provide the following example wallet creation request input, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
    <timestamp>2020-12-31 23:59:59</timestamp>
    <user_accounts_details>
        <user_account_credentials>
            <user_name>JohnDaDoeDoeDoooe@gmail.com</user_name>
            <password>abc123</password>
            //OPTIONAL <cookie>cookieID</cookie>
            //OPTIONAL <digital_cert_link>www.mydigitalcertificate.com/
JohnDoeDaDoeDoe@gmail.com/mycertifcate.dc</digital_cert_link>
            //OPTIONAL <digital_certificate>_DATA_</digital_certificate>
        </user_account_credentials>
    </user_accounts_details>
    <client_details> //iOS Client with App and Webkit
            //it should be noted that although several client details
            //sections are provided to show example variants of client
            //sources, further messages will include only on to save
            //space
        <client_IP>10.0.0.123</client_IP>
        <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
        <client_product_type>iPhone6,1</client_product_type>
        <client_serial_number>DNXXX1X1XXXX</client_serial_number>
        <client_UDID>3XXXXXXXXXXXXXXXXXXXXXXXXD</client_UDID>
        <client_OS>iOS</client_OS>
        <client_OS_version>7.1.1</client_OS_version>
        <client_app_type>app with webkit</client_app_type>
        <app_installed_flag>true</app_installed_flag>
        <app_name>SSITWS.app</app_name>
        <app_version>1.0 </app_version>
        <app_webkit_name>Mobile Safari</client_webkit_name>
        <client_version>537.51.2</client_version>
    </client_details>
    <client_details> //iOS Client with Webbrowser
        <client_IP>10.0.0.123</client_IP>
        <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
        <client_product_type>iPhone6,1</client_product_type>
        <client_serial_number>DNXXX1X1XXXX</client_serial_number>
        <client_UDID>3XXXXXXXXXXXXXXXXXXXXXXXXD</client_UDID>
        <client_OS>iOS</client_OS>
        <client_OS_version>7.1.1</client_OS_version>
        <client_app_type>web browser</client_app_type>
        <client_name>Mobile Safari</client_name>
        <client_version>9537.53</client_version>
    </client_details>
    <client_details> //Android Client with Webbrowser
        <client_IP>10.0.0.123</client_IP>
        <user_agent_string>Mozilla/5.0 (Linux; U; Android 4.0.4; en-us; Nexus S
Build/IMM76D) AppleWebKit/534.30 (KHTML, like Gecko) Version/4.0 Mobile
Safari/534.30</user_agent_string>
        <client_product_type>Nexus S</client_product_type>
        <client_serial_number>YXXXXXXXXZ</client_serial_number>
        <client_UDID>FXXXXXXXXX-XXXX-XXXX-XXXX-XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
    </client_details>
    <client_details> //Mac Desktop with Webbrowser
        <client_IP>10.0.0.123</client_IP>
        <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
        <client_product_type>MacPro5,1</client_product_type>
        <client_serial_number>YXXXXXXXXZ</client_serial_number>
        <client_UDID>FXXXXXXXXX-XXXX-XXXX-XXXX-XXXXXXXXXXXXX</client_UDID>
        <client_OS>Mac OS X</client_OS>
        <client_OS_version>10.9.3</client_OS_version>
        <client_app_type>web browser</client_app_type>
        <client_name>Mobile Safari</client_name>
        <client_version>537.75.14</client_version>
    </client_details>
    <wallet_creation_request_input>
        <request_identifier>ID_request_1</request_identifier>
        <wallet_name>BTC Testnet Wallet</wallet_name>
        <account_key>aMifZnylvYCJs</account_key>
        <asset_type>BTC</asset_type>
        <network_name>testnet</network_name>
    </wallet_creation_request_input>
</auth_request>
```

The application server 106 may send a wallet creation request 125 to a vault server 110 (e.g., running Hashicorp Vault with a custom vault plugin) to request that the vault server create the cryptographic wallet. In one implementation, the wallet creation request may include data such as a request identifier, an authentication token, a wallet name, an account key, an asset type, a network name, and/or the like. In one embodiment, the application server may provide the following example wallet creation request, substantially in the form of a HTTP(S) POST message including XML-formatted data, as provided below:

```
POST /wallet_creation_request.php HTTP/1.1
Host: www.server.com
Content-Type: Application/XML
Content-Length: 667
<?XML version = “1.0” encoding = “UTF-8”?>
<wallet_creation_request>
    <request_identifier>ID_request_2</request_identifier>
    <auth_token>eyJabGciOiJdUzI1NiJ9...</auth_token>
    <wallet_name>BTC Testnet Wallet</wallet_name>
    <account_key>aMifZnylvYCJs</account_key>
    <asset_type>BTC</asset_type>
    <network_name>testnet</network_name>
```

A wallet creation (WAC) component 129 may utilize data provided in the wallet creation request to create the cryptographic wallet. See FIG. 2 for additional details regarding the WAC component.

The vault server 110 may send a wallet key pair generation request 133 to an HSM 114 to facilitate generating a partition for the wallet on the HSM and/or generating a wallet key pair (e.g., an ECDSA key pair). In one implementation, the wallet key pair generation request may include data such as a request identifier, a request type, a wallet identifier, and/or the like. In one embodiment, the vault server may provide the following example wallet key pair generation request, substantially in the form of a HTTP(S) POST message including XML-formatted data, as provided below:

```
POST /wallet_key_pair_generation_request.php HTTP/1.1
Host: www.server.com
Content-Type: Application/XML
Content-Length: 667
<?XML version = “1.0” encoding = “UTF-8”?>
<wallet_key_pair_generation_request>
    <request_identifier>ID_request_3</request_identifier>
    <request_type>NEW_WALLET</request_type>
    <wallet_identifier>555</wallet_identifier>
</wallet_key_pair_generation_request>
```

The HSM 114 may send a wallet key pair generation response 137 to the vault server 110 with information regarding the generated wallet key pair. In one implementation, the wallet key pair generation response may include data such as a response identifier, an HSM wallet identifier, generated wallet key pair information, and/or the like. In one embodiment, the HSM may provide the following example wallet key pair generation response (e.g., when interacting with the HSM when generating an ECDSA key pair with a specific curve (e.g., secp256k1 curve)), substantially in the form of a HTTP(S) POST message including XML-formatted data, as provided below:

```
POST /wallet_key_pair_generation_response.php HTTP/1.1
Host: www.server.com
Content-Type: Application/XML
Content-Length: 667
<?XML version = “1.0” encoding = “UTF-8”?>
<wallet_key_pair_generation_response>
    <response_identifier>ID_response_3</response_identifier>
    <HSM_wallet_identifier>123-456-789</HSM_wallet_identifier>
    <wallet_key_pair_information>
        Key pair generated:
        Private Key Object; EC
```

| | |
|---|---|
| label: | defaultkey |
| ID: | 12 |
| Usage: | decrypt, sign, unwrap |

```
        Public Key Object; EC EC_POINT 256 bits
          EC_POINT:
0441044e68fd16a81555c2bf448d25b767572c398ac9706298c748d9bd3
c88557bb161bef155491140fdc2541c5f032d73abcedd4b6540021b615c
2467bbf9bf04c5b8
```

| | |
|---|---|
| EC_PARAMS: | 06082a8648ce3d030107 |
| label: | defaultkey |
| ID: | 12 |
| Usage: | encrypt, verify, wrap |

</wallet_key_pair_information>
</wallet_key_pair_generation_response>

In another embodiment, the HSM may provide the following example wallet key pair generation response (e.g., when interacting with the HSM through a cloud provider managing storage and physical access to hardware (e.g., Azure HSM)), substantially in the form of a HTTP(S) POST message including XML-formatted data, as provided below:

```
POST /wallet_key_pair_generation_response.php HTTP/1.1
Host: www.server.com
Content-Type: Application/XML
Content-Length: 667
<?XML version = “1.0” encoding = “UTF-8”?>
<wallet_key_pair_generation_response>
    <response_identifier>ID_response_3</response_identifier>
    <HSM_wallet_identifier>123-456-789</HSM_wallet_identifier>
    <wallet_key_pair_information>
    {
        key: {
            kid: ‘$STORAGE_URI’,
            kty: ‘$KEY_TYPE_ID’,
            keyOps: [ ‘sign’, ‘verify’ ],
            crv: ‘SECP256K1’,
            x: <Buffer ...>,
            y: <Buffer ...>,
        },
        attributes: {
            enabled: true,
            created: 2018-09-05T18:35:53.000Z,
            updated: 2018-09-05T18:35:53.000Z,
            recoveryLevel: ‘Purgeable’
        }
    }
    </wallet_key_pair_information>
</wallet_key_pair_generation_response>
```

The vault server 110 may send a wallet creation response 141 to the application server 106 to confirm that the cryptographic wallet was created successfully. In one implementation, the wallet creation response may include data such as a response identifier, a status, and/or the like. In one embodiment, the vault server may provide the following example wallet creation response, substantially in the form of a HTTP(S) POST message including XML-formatted data, as provided below:

```
POST /wallet_creation_response.php HTTP/1.1
Host: www.server.com
Content-Type: Application/XML
Content-Length: 667
<?XML version = “1.0” encoding = “UTF-8”?>
<wallet_creation_response>
    <response_identifier>ID_response_2</response_identifier>
    <status>OK</status>
</wallet_creation_response>
```

The application server 106 may send a wallet creation response output 145 to the client 102 to inform the user that the cryptographic wallet was created successfully. In one implementation, the wallet creation response output may include data such as a response identifier, a status, and/or the like. In one embodiment, the application server may provide the following example wallet creation response output, substantially in the form of a HTTP(S) POST message including XML-formatted data, as provided below:

```
POST /wallet_creation_response_output.php HTTP/1.1
Host: www.server.com
Content-Type: Application/XML
Content-Length: 667
<?XML version = “1.0” encoding = “UTF-8”?>
<wallet_creation_response_output>
  <response_identifier>ID_response_1</response_identifier>
  <status>OK</status>
</wallet_creation_response_output>
```

The client 102 may send a workflow creation request input 149 to the application server 106 to facilitate creating a workflow policy for the cryptographic wallet. In one implementation, the workflow creation request input may include data such as a request identifier, an authentication token, a wallet identifier, an account key, a workflow identifier, a workflow name, workflow rules, number of signatures for workflow approval, signing groups configuration, and/or the like. In one embodiment, the client may provide the following example workflow creation request input, substantially in the form of a HTTP(S) POST message including XML-formatted data, as provided below:

```
POST /workflow_creation_request_input.php HTTP/1.1
Host: www.server.com
Content-Type: Application/XML
Content-Length: 667
<?XML version = “1.0” encoding = “UTF-8”?>
<workflow_creation_request_input>
  <request_identifier>ID_request_4</request_identifier>
  <auth_token>eyJabGciOiJdUzI1NiJ9...</auth_token>
  <wallet_identifier>555</wallet_identifier>
  <account_key>aMifZnylvYCJs</account_key>
  <workflow_identifier>ID_workflow_1</workflow_identifier>
  <workflow_name>Large Trades</workflow_name>
  <workflow_rules>
    <hours_of_operation>Monday-Friday, 8:30am-4:30pm</
    hours_of_operation>
    <min_threshold>$50,000</min_threshold>
    <max_threshold>$50,000,000</max_threshold>
    <addresses_whitelist>mkv...1Lf, mgj...QGg</addresses_whitelist>
  </workflow_rules>
  <approval_signatures>3 of 5</approval_signatures>
  <signing_groups>
    <group>
      <group_identifier>ID_group_1</group_identifier>
      <authorized_signers>ID_user_1, ID_user_3</
      authorized_signers>
    </group>
    <group>
      <group_identifier>ID_group_2</group_identifier>
      <authorized_signers>ID_user_2, ID_user_4, ID_user_5</
      authorized_signers>
    </group>
    ...
  </signing_groups>
</workflow_creation_request_input>
```

The application server 106 may send a workflow creation request 153 to the vault server 110 to request that the vault server create the workflow policy for the cryptographic wallet. In one implementation, the workflow creation request may include data such as a request identifier, an authentication token, a wallet identifier, an account key, a workflow identifier, a workflow name, workflow rules, number of signatures for workflow approval, signing groups configuration, and/or the like. In one embodiment, the application server may provide the following example workflow creation request, substantially in the form of a HTTP(S) POST message including XML-formatted data, as provided below:

```
POST /workflow_creation_request.php HTTP/1.1
Host: www.server.com
Content-Type: Application/XML
Content-Length: 667
<?XML version = “1.0” encoding = “UTF-8”?>
<workflow_creation_request>
  <request_identifier>ID_request_5</request_identifier>
  <auth_token>eyJabGciOiJdUzI1NiJ9...</auth_token>
  <wallet_identifier>555</wallet_identifier>
  <account_key>aMifZnylvYCJs</account_key>
  <workflow_identifier>ID_workflow_1</workflow_identifier>
  <workflow_name>Large Trades</workflow_name>
  <workflow_rules>
    <hours_of_operation>Monday-Friday, 8:30am-4:30pm</
    hours_of_operation>
    <min_threshold>$50,000</min_threshold>
    <max_threshold>$50,000,000</max_threshold>
    <addresses_whitelist>mkv...1Lf, mgj...QGg</addresses_whitelist>
  </workflow_rules>
  <approval_signatures>3 of 5</approval_signatures>
  <signing_groups>
    <group>
      <group_identifier>ID_group_1</group_identifier>
      <authorized_signers>ID_user_1, ID_user_3</
      authorized_signers>
    </group>
    <group>
      <group_identifier>ID_group_2</group_identifier>
      <authorized_signers>ID_user_2, ID_user_4, ID_user_5</
      authorized_signers>
    </group>
    <group>
      <group_identifier>ID_group_3</group_identifier>
      <authorized_signers>ID_user_6, ID_user_7</
      authorized_signers>
    </group>
    ...
  </signing_groups>
</workflow_creation_request>
```

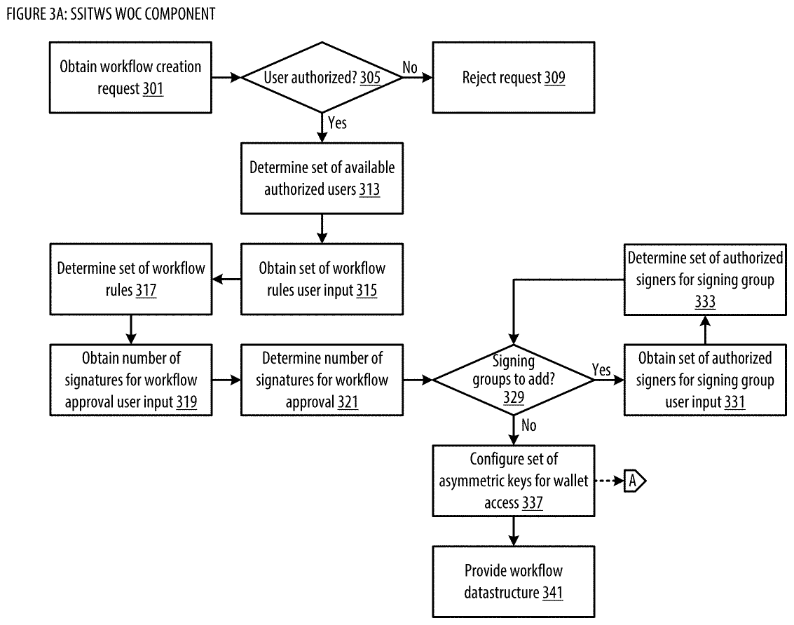

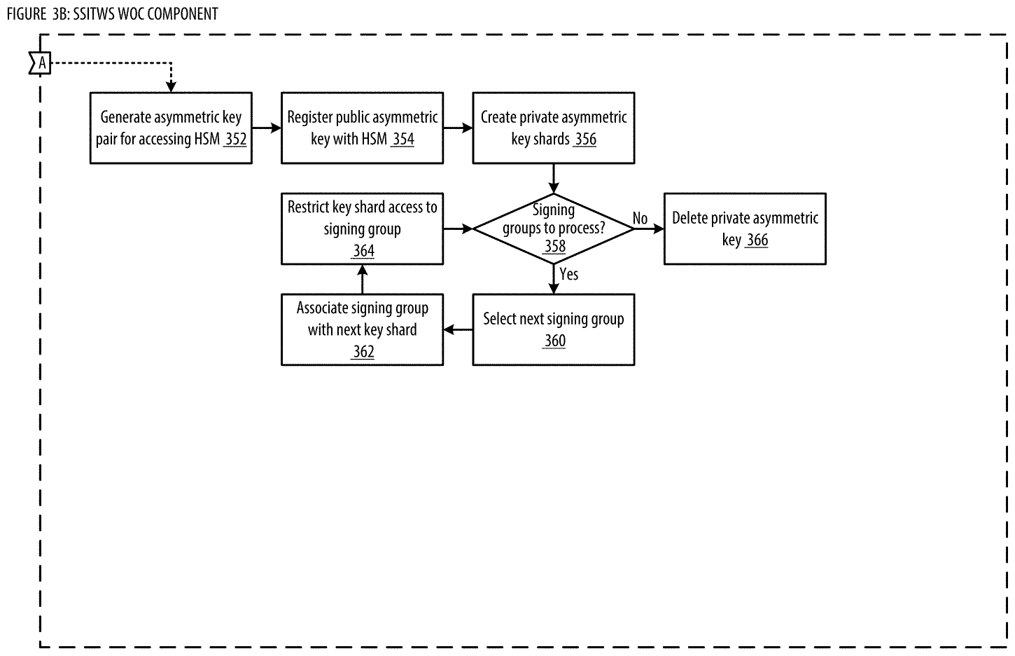

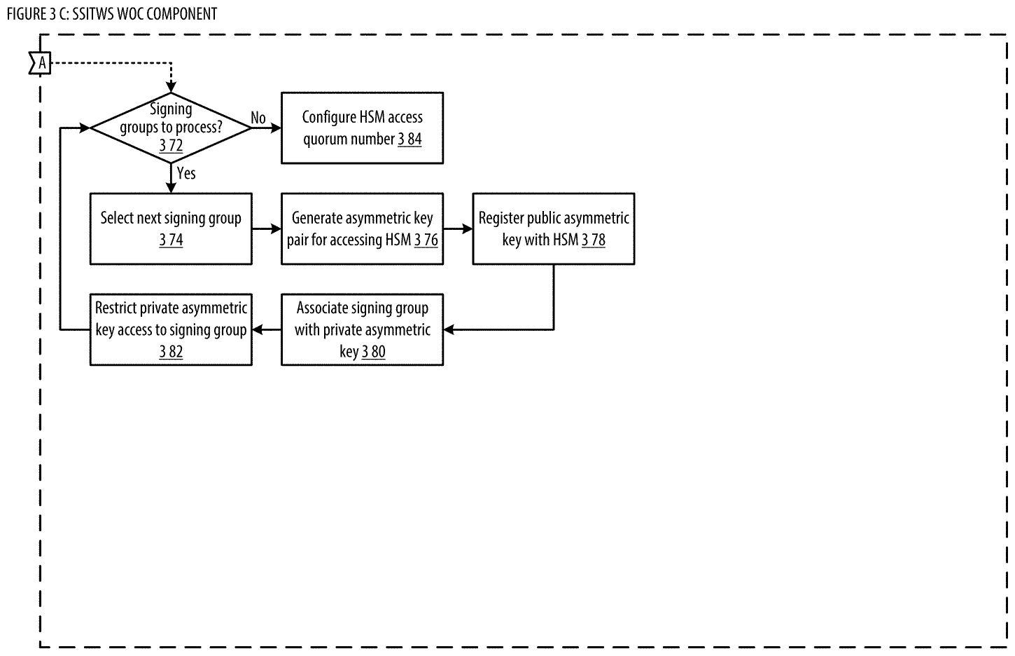

A workflow creation (WOC) component 157 may utilize data provided in the workflow creation request to create the workflow policy for the cryptographic wallet. See FIGS. 3A-C for additional details regarding the WOC component.

The vault server 110 may send an authorized users request 161 to an authentication server 118 (e.g., Azure Active Directory) to determine authorized users that may be selected as authorized signers when the user configures a signing group. In one implementation, the authorized users request may include data such as a request identifier, a request type, an account key, and/or the like. In one embodiment, the vault server may provide the following example authorized users request, substantially in the form of a HTTP(S) POST message including XML-formatted data, as provided below:

```
POST /authorized_users_request.php HTTP/1.1
Host: www.server.com
Content-Type: Application/XML
Content-Length: 667
<?XML version = “1.0” encoding = “UTF-8”?>
<authorized_users_request>
  <request_identifier>ID_request_6</request_identifier>
  <request_type>GET_USERS_LIST</request_type>
  <account_key>aMifZnylvYCJs</account_key>
</authorized_users_request>
```

The authentication server 118 may send an authorized users response 165 to the vault server 110 with information regarding the authorized users. In one implementation, the authorized users response may include data such as a response identifier, authorized users information, and/or the like. In one embodiment, the authentication server may provide the following example authorized users response, substantially in the form of a HTTP(S) POST message including XML-formatted data, as provided below:

```
POST /authorized_users_response.php HTTP/1.1
Host: www.server.com
Content-Type: Application/XML
Content-Length: 667
<?XML version = “1.0” encoding = “UTF-8”?>
<authorized_users_response>
  <response_identifier>ID_response_6</response_identifier>
  <authorized_users_information>
    <user>
      <user_identifier>ID_user_1</user_identifier>
      <name>Alice</name>
      <email>alice@account_address.com</email>
    </user>
    <user>
      <user_identifier>ID_user_2</user_identifier>
      <name>Bob</name>
      <email>bob@account_address.com</email>
    </user>
    <user>
      <user_identifier>ID_user_6</user_identifier>
      <name>Dave</name>
      <email>dave@account_address.com</email>
    </user>
    ...
  </authorized_users_information>
</authorized_users_response>
```

The vault server 110 may send a workflow creation response 169 to the application server 106 to confirm that the workflow policy was created successfully. In one implementation, the workflow creation response may include data such as a response identifier, a status, and/or the like. In one embodiment, the vault server may provide the following example workflow creation response, substantially in the form of a HTTP(S) POST message including XML-formatted data, as provided below:

```
POST /workflow_creation_response.php HTTP/1.1
Host: www.server.com
Content-Type: Application/XML
Content-Length: 667
<?XML version = “1.0” encoding = “UTF-8”?>
<workflow_creation_response>
  <response_identifier>ID_response_5</response_identifier>
  <status>OK</status>
</workflow_creation_response>
```

The application server 106 may send a workflow creation response output 173 to the client 102 to inform the user that the workflow policy was created successfully. In one implementation, the workflow creation response output may include data such as a response identifier, a status, and/or the like. In one embodiment, the application server may provide the following example workflow creation response output, substantially in the form of a HTTP(S) POST message including XML-formatted data, as provided below:

```
POST /workflow_creation_response_output.php HTTP/1.1
Host: www.server.com
Content-Type: Application/XML
Content-Length: 667
<?XML version = “1.0” encoding = “UTF-8”?>
<workflow_creation_response_output>
  <response_identifier>ID_response_4</response_identifier>
  <status>OK</status>
</workflow_creation_response_output>
```

FIG. 2 shows a logic flow illustrating embodiments of a wallet creation (WAC) component for the SSITWS. In FIG. 2, a wallet creation request may be obtained at 201. For example, the wallet creation request may be obtained as a result of a user request to create a cryptographic wallet.

A determination may be made at 205 whether the requesting user is authorized to request creation of a cryptographic wallet. In one implementation, the user's authentication token (e.g., obtained by the user after the user provides a username and password) may be checked to verify that the user is authorized. If the user is not authorized, the request may be rejected at 209. For example, the user may be prompted to provide valid login credentials.

If the user is authorized, a cryptographic asset type associated with the cryptographic wallet may be determined at 213. For example, the cryptograph asset type may be Bitcoin, Ethereum, Dash, Algorand, and/or the like. In one implementation, the wallet creation request may be parsed (e.g., using PHP commands) to determine the specified cryptographic asset type (e.g., based on the value of the asset_type field).

A network associated with the cryptographic wallet may be determined at 217. For example, the network may be mainnet, testnet, and/or the like. In one implementation, the wallet creation request may be parsed (e.g., using PHP commands) to determine the specified network (e.g., based on the value of the network_name field).

A wallet name associated with the cryptographic wallet may be determined at 221. For example, the wallet name may be an easily recognizable name that the user may utilize to identify different cryptographic wallets in an account (e.g., a collection of cryptographic wallets used for organizational purposes). In one implementation, the wallet creation request may be parsed (e.g., using PHP commands) to determine the specified wallet name (e.g., based on the value of the wallet_name field).

A wallet identifier for the cryptographic wallet may be generated at 225. For example, the wallet identifier may be used to identify data associated with the cryptographic wallet stored on an HSM. In one implementation, the wallet identifier (e.g., wallet-id: 555) may be generated by the WAC component. In another implementation, the wallet identifier (e.g., azure-key-id: 123-456-789) may be provided by the HSM (e.g., when requesting wallet partition generation and/or wallet key pair generation from the HSM).

A wallet partition generation may be requested from the HSM at 229. For example, data associated with each cryptographic wallet may be stored on its own HSM partition for increased security. In one implementation, the WAC component may make an API call to the HSM to request wallet partition generation. For example, each partition may utilize distinct security officer (e.g., responsible for administering the partition), IP address, port, elliptic curve, and/or the like.

A wallet key pair generation may be requested from the HSM at 233. For example, an ECDSA key pair utilized to control the cryptographic wallet may be generated and stored on the HSM. In one implementation, the WAC component may make an API call to the HSM to request wallet key pair generation. In another implementation, the WAC component may make an API call to an HSM cloud provider product (e.g., Azure Key Vault) to request wallet key pair generation. In one embodiment, the private key of the generated wallet key pair does not leave the HSM.

The cryptographic wallet's public key may be determined from the HSM at 237. In one implementation, the public key of the generated wallet key pair may be returned to the WAC component as a result of making an API call to request wallet key pair generation.

A hash of the cryptographic wallet's public key may be determined at 241. For example, the hash of the public key may be used as the cryptographic wallet's public address that can be utilized to send funds into the cryptographic wallet. In one implementation, the hash may be calculated using Base58Check(RIPEMD160(SHA256(public key)).

A wallet datastructure may be provided at 245. For example, a wallet datastructure may comprise any of the data regarding the cryptographic wallet that may be stored in the wallets table 2019j, and may be similar to the following:

```
Wallet
{
  walletID: 555,
  walletName: BTC Testnet Wallet,
  walletNetwork: testnet,
  walletLinkedAccountID: aMifZnylvYCJs,
  walletCryptographicAssetType: BTC,
  walletAddress: 2MsWfv5oFZAGEozsdzsaYMQf6c8HUEmtyqx,
  walletBalance: 0,
  walletStatus: ACTIVE
}
```

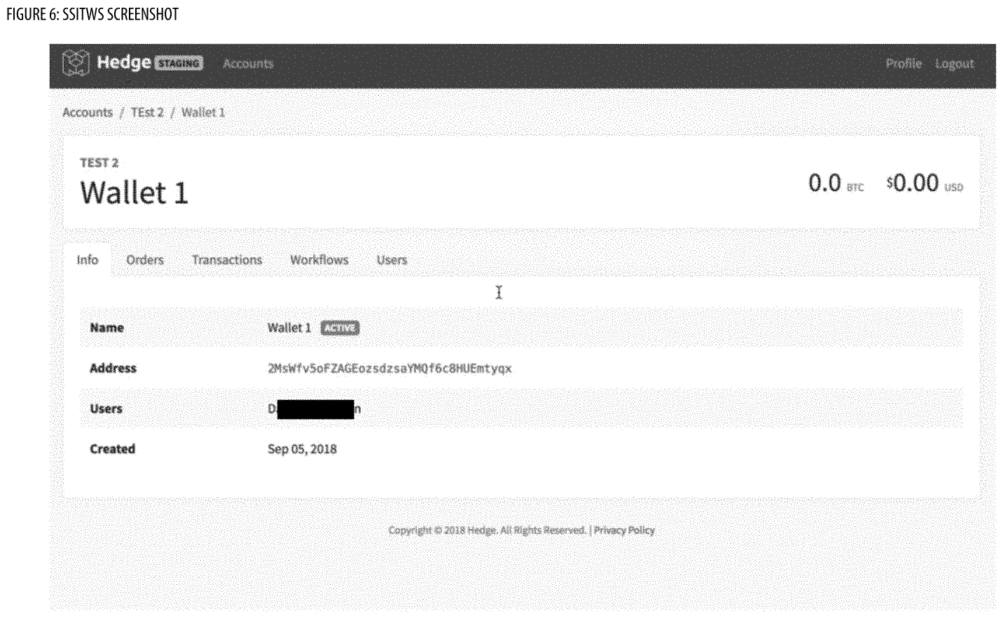

In one implementation, the wallet datastructure may be saved to the wallets table 2019j. In another implementation, the wallet datastructure may be returned to the caller of the WAC component (e.g., a Rails app running on an application server). See FIG. 6 for an example of information that may be provided to the user based on data in the wallet datastructure.

FIGS. 3A-C show a logic flow illustrating embodiments of a workflow creation (WOC) component for the SSITWS. In FIG. 3A, a workflow creation request may be obtained at 301. For example, the workflow creation request may be obtained as a result of a user request to create a workflow policy for a cryptographic wallet.

A determination may be made at 305 whether the requesting user is authorized to request creation of a workflow policy for the cryptographic wallet. In one implementation, the user's authentication token (e.g., obtained by the user after the user provides a username and password) may be checked to verify that the user is authorized. If the user is not authorized, the request may be rejected at 309. For example, the user may be prompted to provide valid login credentials.

If the user is authorized, a set of available authorized users (e.g., for an account associated with the cryptographic wallet) may be determined at 313. For example, users in the set of available authorized users may be selected as authorized signers when the user configures a signing group. In one implementation, the WOC component may send an authorized users request to an authentication server to determine the set of available authorized users. In another implementation, a database may be queried to determine the set of available authorized users. For example, the set of available authorized users may be determined via a MySQL database command similar to the following:
SELECT userIDs
FROM Accounts
WHERE accountID=aMifZnylvYCJs;

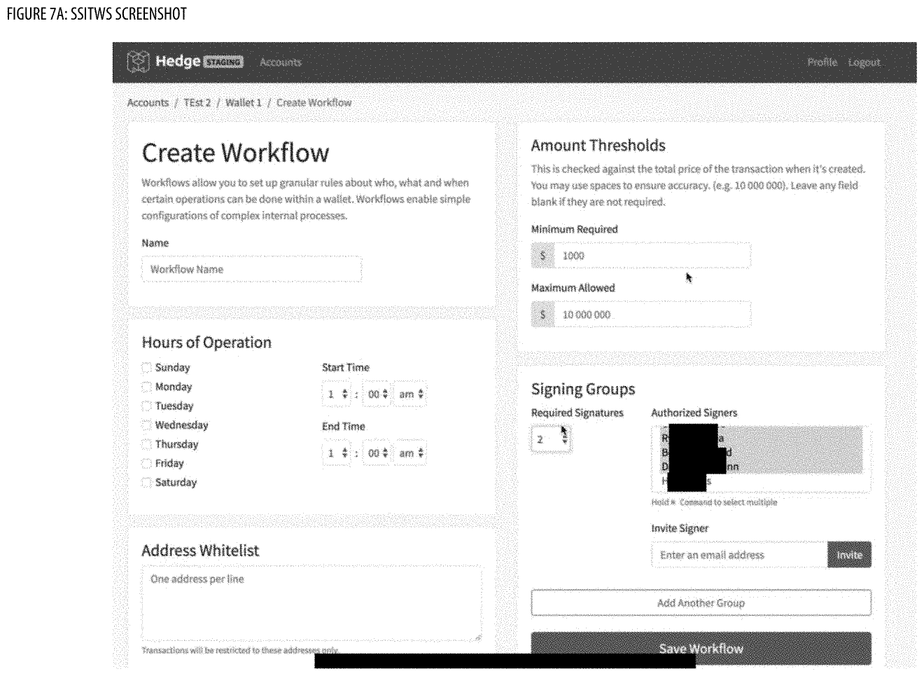

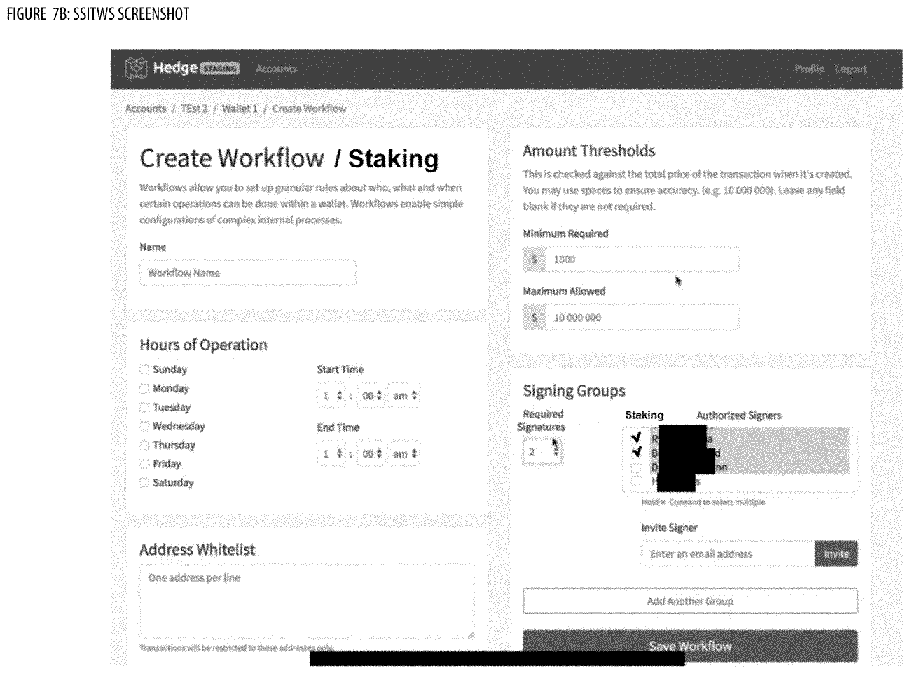

User input regarding a set of workflow rules for the workflow policy may be obtained at 315. See FIGS. 7A-B for examples of user interfaces that may be utilized by the user to provide input regarding the set of workflow rules for the workflow policy. The set of workflow rules may be determined at 317. In various embodiments, the set of workflow rules may include hours of operations (e.g., days and/or hours during which the workflow policy may be executed), amount thresholds (e.g., minimum and/or maximum amounts that may be transferred under the workflow policy), address whitelist (e.g., a set of addresses to which transactions are allowed under the workflow policy), and/or the like. In one implementation, user input regarding the set of workflow rules may be parsed (e.g., using PHP commands) to determine the set of workflow rules.

User input regarding the number of approval signatures to utilize for the workflow policy may be obtained at 319. In one embodiment, a transaction may not be approved under the workflow policy until the specified number of approval signatures to utilize for the transaction is obtained. See FIGS. 7A-B for examples of user interfaces that may be utilized by the user to provide input regarding the number of approval signatures to utilize. The number of approval signatures to utilize for workflow approval may be determined at 321. In one implementation, user input regarding the number of approval signatures to utilize may be parsed (e.g., using PHP commands) to determine the number of approval signatures to utilize.

A determination may be made at 329 whether there remain signing groups to add for the workflow policy. In one implementation, the user may add as many signing groups as the user wishes. For example, the user may be requested to specify at least as many signing groups (e.g., N) as the determined number of approval signatures to utilize for workflow approval (e.g., M). In one embodiment, each signing group may provide one approval signature, resulting in M-of-N (e.g., 3-of-5) approval method for transactions under the workflow policy. In some embodiments, a signing group may comprise a 3^{rd} party (e.g., a custodian who may assist with wallet access key recovery in case another signing group loses its private key).

If there remain signing groups to add for the workflow policy, user input regarding a set of authorized signers for the current signing group may be obtained at 331. In one embodiment, any authorized signer may provide an approval signature for a signing group. In another embodiment, a specified combination (e.g., any two) of authorized signers may be utilized to provide an approval signature for a signing group. In some embodiments, the user may specify whether staking rewards should be provided to an authorized signer. See FIGS. 7A-B for examples of user interfaces that may be utilized by the user to provide input regarding the set of authorized signers for the current signing group. The set of authorized signers for the current signing group may be determined at 333. In one implementation, user input regarding the set of authorized signers may be parsed (e.g., using PHP commands) to determine the set of authorized signers for the current signing group.

A set of asymmetric keys utilized for wallet access may be configured at 337. In one embodiment, an asymmetric key pair (e.g., an RSA private key and public key pair), which allows requesting transaction signing from an HSM for transactions associated with the cryptographic wallet, may be generated and split into shards associated with the signing groups for the workflow policy. See FIG. 3B for additional details regarding this embodiment. In another embodiment, a set of asymmetric key pairs (e.g., RSA private key and public key pairs), associated with the signing groups for the workflow policy, which in combination allow requesting transaction signing from an HSM for transactions associated with the cryptographic wallet, may be generated. See FIG. 3C for additional details regarding this embodiment.

A workflow policy datastructure may be provided at 341. For example, a workflow policy datastructure may comprise any of the data regarding the workflow policy that may be stored in the policies table 2019k, and may be similar to the following:

```
WorkflowPolicy
{
  workflowPolicyID: ID_workflow_1,
  workflowPolicyName: Large Trades,
  workflowPolicyLinkedWalletID: 555,
  workflowPolicyMinNumberSignatures: 3,
  workflowPolicyNumberSigningGroups: 5,
  workflowPolicySigningGroupsConfiguration: signing groups data,
  workflowPolicyOperatingHoursConfiguration: Monday-Friday,
  8:30am-4:30pm,
  workflowPolicyMinAmountThreshold: $50,000.01,
  workflowPolicyMaxAmountThreshold: $50,000,000.00,
  workflowPolicyAddressWhitelist: mkv...1Lf, mgj...QGg
}
```

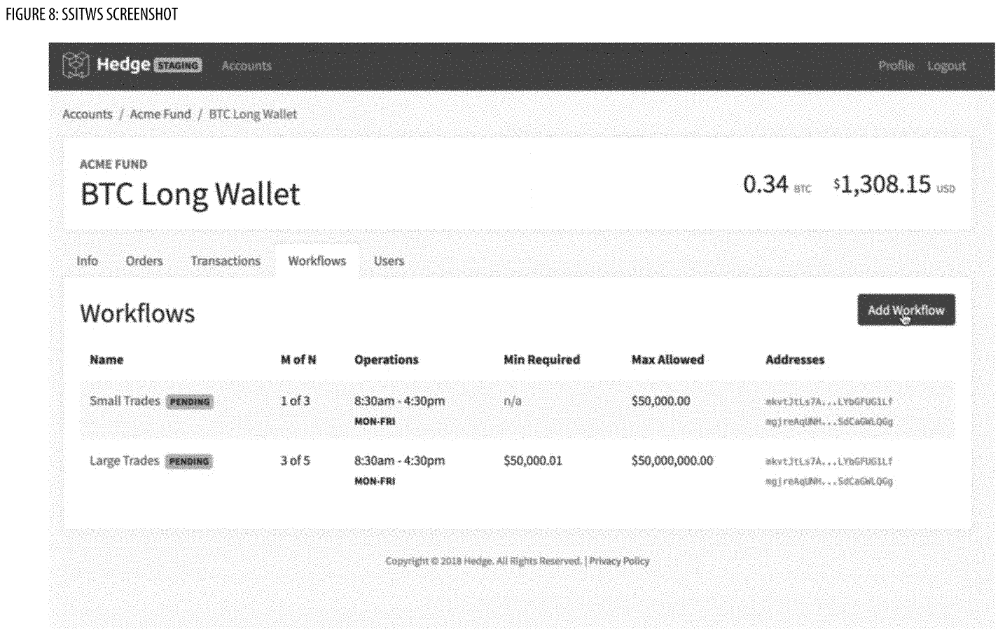

In one implementation, the workflow policy datastructure may be saved to the policies table 2019k. In another implementation, the wallet datastructure may be returned to the caller of the WOC component (e.g., a Rails app running on an application server). See FIG. 8 for an example of information that may be provided to the user based on data in the workflow policy datastructure.

FIG. 3B shows a logic flow illustrating embodiments of a workflow creation (WOC) component for the SSITWS. In FIG. 3B, an asymmetric key pair for accessing an HSM associated with the cryptographic wallet may be generated at 352. In one implementation, an RSA private key and public key pair may be generated.

The asymmetric public key may be registered with the HSM at 354. In one implementation, the WOC component may make an API call to the HSM to request registration of the asymmetric public key.

Key shards may be created from the asymmetric private key at 356. In one implementation, Shamir secret sharing (SSS) cryptographic method may be utilized to create the key shards from the asymmetric private key. For example, if the workflow policy is configured to utilize 3-of-5 approval method, 5 key shards may be created with any 3 sufficient to reconstruct the asymmetric private key.

A determination may be made at 358 whether there remain signing groups to process. In one implementation, each of the signing groups associated with the workflow policy may be processed. If there remain signing groups to process, the next signing group may be selected for processing at 360.

The selected signing group may be associated with the next key shard at 362. In one embodiment, each signing group may thus be associated with a different key shard. Access to the associated key shard may be restricted to the selected signing group at 364. In one implementation, access to the associated key shard may be restricted to the set of authorized signers in the selected signing group. In some implementations, access to the associated key shard may utilize multi-factor authentication for authorized signers (e.g., including a hardened physical key (e.g., YubiKey) and/or an authenticator app (e.g., Authy)). In some implementations, different key shards may be stored in different vault servers. In some implementations, different key shards may be stored in different HSMs.

The asymmetric private key may be deleted from memory at 366. Accordingly, in order to request transaction signing from the HSM, the asymmetric private key would have to be reconstructed from M-of-N key shards.

FIG. 3C shows a logic flow illustrating embodiments of a workflow creation (WOC) component for the SSITWS. In FIG. 3C, a determination may be made at 372 whether there remain signing groups to process. In one implementation, each of the signing groups associated with the workflow policy may be processed. If there remain signing groups to process, the next signing group may be selected for processing at 374.

An asymmetric key pair for accessing an HSM associated with the cryptographic wallet may be generated at 376. In one implementation, an RSA private key and public key pair may be generated.

The asymmetric public key may be registered with the HSM as one of M-of-N public keys at 378. In one implementation, the WOC component may make an API call to the HSM to request M-of-N registration of the asymmetric public key.

The asymmetric private key may be associated with the selected signing group at 380. In one embodiment, each signing group may thus be associated with a different asymmetric private key. Access to the associated asymmetric private key may be restricted to the selected signing group at 382. In one implementation, access to the associated asymmetric private key may be restricted to the set of authorized signers in the selected signing group. In some implementations, access to the associated asymmetric private key may utilize multi-factor authentication for authorized signers (e.g., including a hardened physical key (e.g., YubiKey) and/or an authenticator app (e.g., Authy)). In some implementations, different asymmetric private keys may be stored in different vault servers. In some implementations, different asymmetric private keys may be stored in different HSMs.

The HSM may be configured to grant access based on a quorum number of signatures at 384. For example, if the workflow policy is configured to utilize 3-of-5 approval method, the quorum number may be set to 3. Accordingly, in order to request transaction signing from the HSM, 3 of the 5 signing groups would have to sign the transaction using their associated asymmetric private keys.

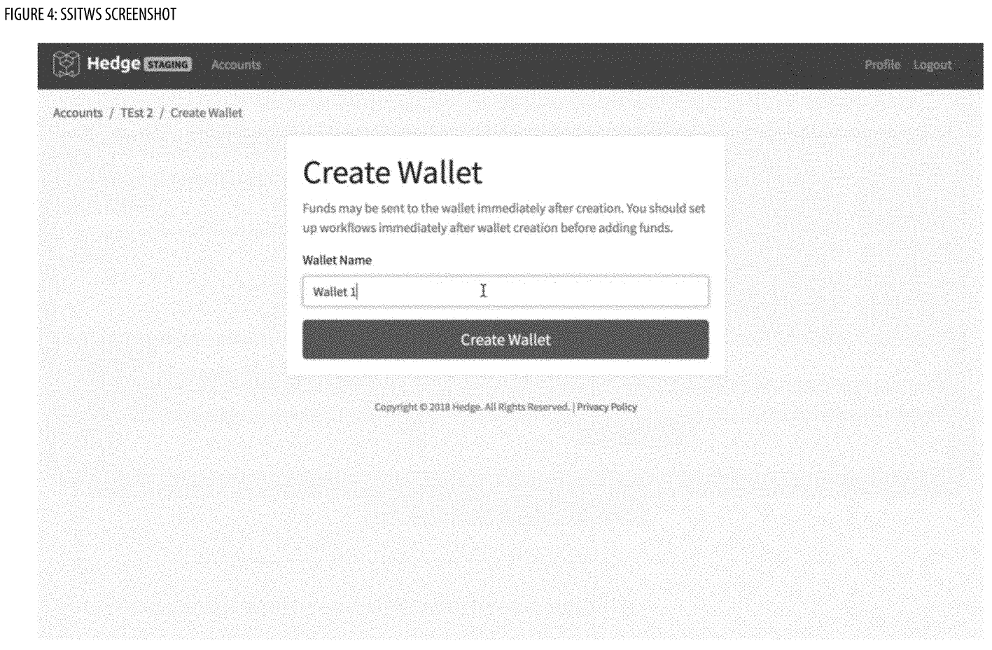

FIG. 4 shows a screenshot illustrating user interface(s) of the SSITWS. In FIG. 4, an exemplary user interface (e.g., for a mobile device, for a website) for requesting creation of a cryptographic wallet is illustrated.

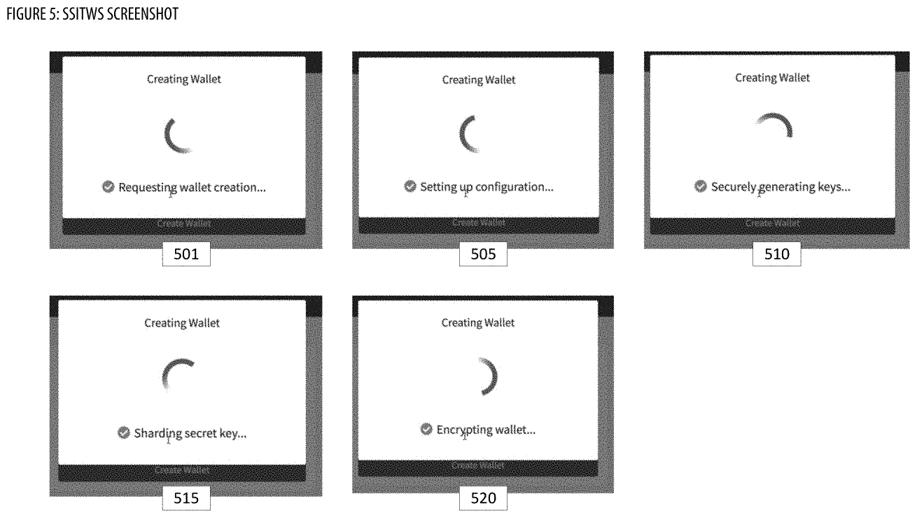

FIG. 5 shows a screenshot illustrating user interface(s) of the SSITWS. In FIG. 5, an exemplary user interface (e.g., for a mobile device, for a website) for showing progress when creating a cryptographic wallet is illustrated. Screen 501 shows that wallet creation is requested. Screen 505 shows that configuration is set up. Screen 510 shows that keys are generated. Screen 515 shows that a secret key is sharded. Screen 520 shows that wallet information (e.g., including associated workflow policy information) is encrypted in vault server storage (e.g., using 256-bit AES in GCM mode with a randomly generated nonce prior to writing data to its persistent storage).

FIG. 6 shows a screenshot illustrating user interface(s) of the SSITWS. In FIG. 6, an exemplary user interface (e.g., for a mobile device, for a website) for showing a user information regarding a cryptographic wallet is illustrated.

FIG. 7A shows a screenshot illustrating user interface(s) of the SSITWS. In FIG. 7A, an exemplary user interface (e.g., for a mobile device, for a website) for configuring a workflow policy is illustrated. For example, the Required Signatures widget may be utilized to specify the number of approval signatures (e.g., 2).

FIG. 7B shows a screenshot illustrating user interface(s) of the SSITWS. In FIG. 7A, an exemplary user interface (e.g., for a mobile device, for a website) for configuring a workflow policy and/or staking is illustrated. For example, the Staking checkbox widgets may be utilized to specify which authorized signers should receive staking rewards.

FIG. 8 shows a screenshot illustrating user interface(s) of the SSITWS. In FIG. 8, an exemplary user interface (e.g., for a mobile device, for a website) for showing a user information regarding workflow policies associated with a cryptographic wallet is illustrated.

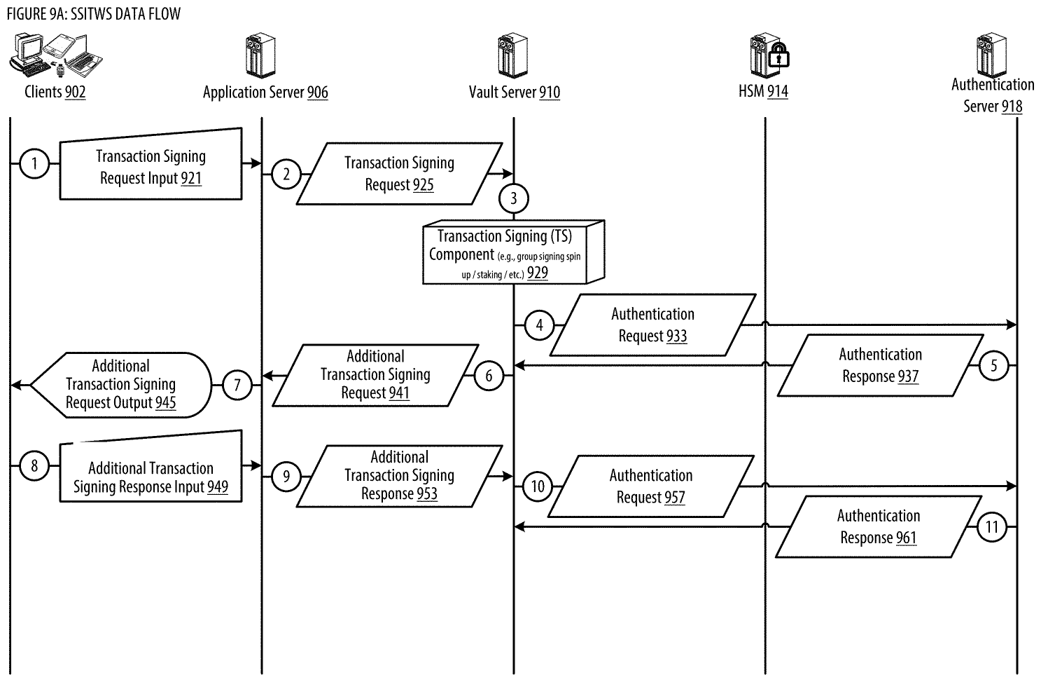

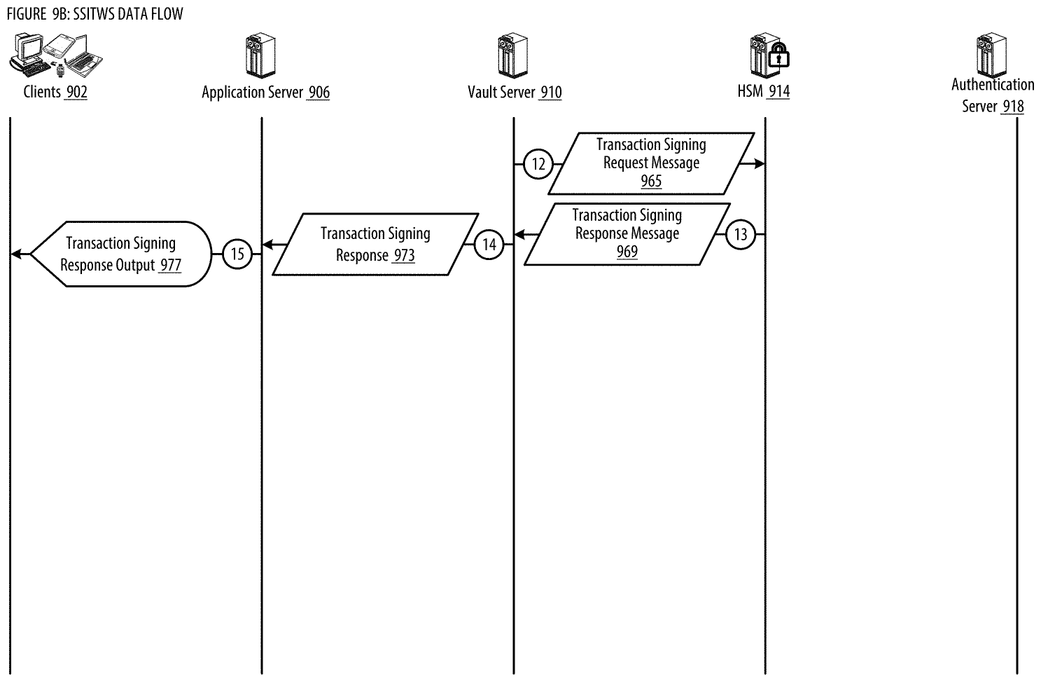

FIGS. 9A-B show a datagraph illustrating data flow(s) for the SSITWS. In FIGS. 9A-B, one of clients 902 (e.g., of a user) may send a transaction signing request input 921 to an application server 906 (e.g., running a Rails app) to facilitate signing a transaction (e.g., to transfer cryptocurrency) associated with a cryptographic wallet. In one implementation, the transaction signing request input may include data such as a request identifier, a user identifier, authentication data (e.g., using multi-factor authentication), a transaction identifier, a transaction type, a wallet identifier, an asset type, a transaction amount, a recipient address, and/or the like. In one embodiment, the user's client may provide the following example transaction signing request input, substantially in the form of a HTTP(S) POST message including XML-formatted data, as provided below:

```
POST /transaction_signing_request_input.php HTTP/1.1
Host: www.server.com
Content-Type: Application/XML
Content-Length: 667
<?XML version = “1.0” encoding = “UTF-8”?>
<transaction_signing_request_input>
  <request_identifier>ID_request_11</request_identifier>
  <user_identifier>ID_user_1</user_identifier>
  <first_authentication_data>password1</first_authentication_data>
  <second_authentication_data>pin1</second_authentication_data>
  <transaction_identifier>ID_transaction_1</transaction_identifier>
  <transaction_type>TRANSFER</transaction_type>
  <wallet_identifier>555</wallet_identifier>
  <asset_type>BTC</asset_type>
  <transaction_amount>1</transaction_amount>
  <recipient_address>mkv...1Lf</recipient_address>
</transaction_signing_request_input>
```

The application server 906 may send a transaction signing request 925 to a vault server 910 (e.g., running Hashicorp Vault with a custom vault plugin) to request that the vault server facilitate signing the transfer transaction. In one implementation, the transaction signing request may include data such as a request identifier, a user identifier, authentication data, a transaction identifier, a transaction type, a wallet identifier, an asset type, a transaction amount, a recipient address, and/or the like. In one embodiment, the application server may provide the following example transaction signing request, substantially in the form of a HTTP(S) POST message including XML-formatted data, as provided below:

```
POST /transaction_signing_request.php HTTP/1.1
Host: www.server.com
Content-Type: Application/XML
Content-Length: 667
<?XML version = “1.0” encoding = “UTF-8”?>
<transaction_signing_request>
  <request_identifier>ID_request_12</request_identifier>
  <user_identifier>ID_user_1</user_identifier>
  <first_authentication_data>password1</first_authentication_data>
  <second_authentication_data>pin1</second_authentication_data>
  <transaction_identifier>ID_transaction_1</transaction_identifier>
  <transaction_type>TRANSFER</transaction_type>
  <wallet_identifier>555</wallet_identifier>
  <asset_type>BTC</asset_type>
  <transaction_amount>1</transaction_amount>
  <recipient_address>mkv...1Lf</recipient_address>
</transaction_signing_request>
```

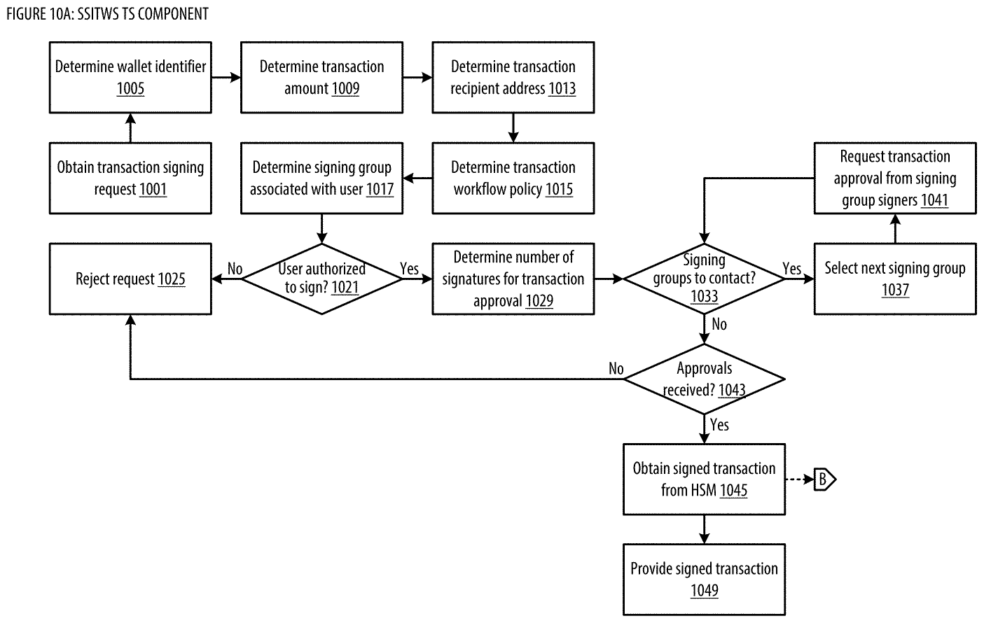

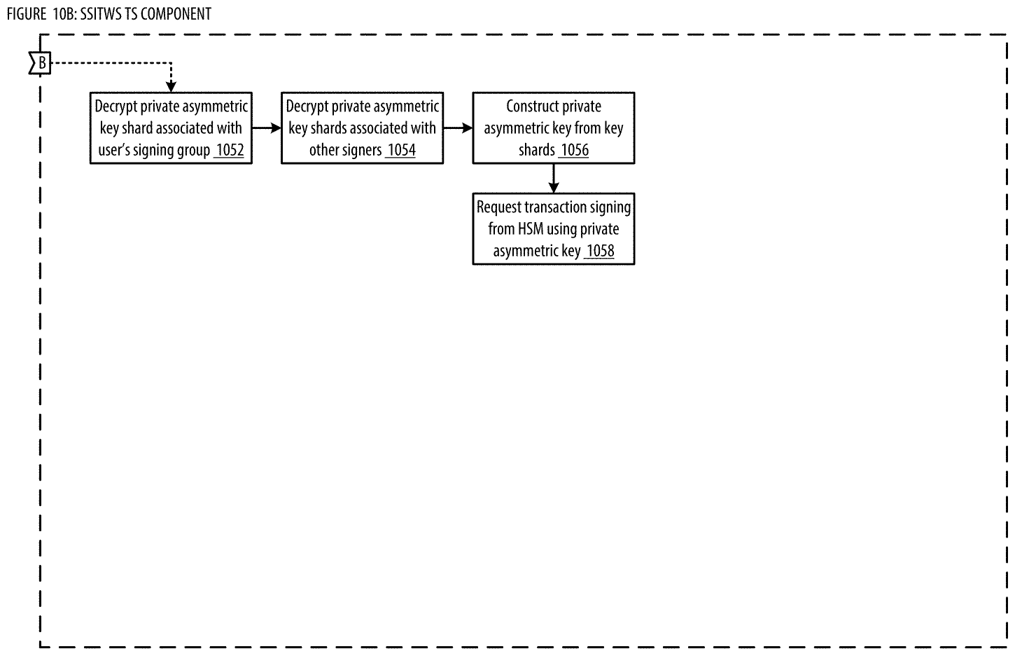

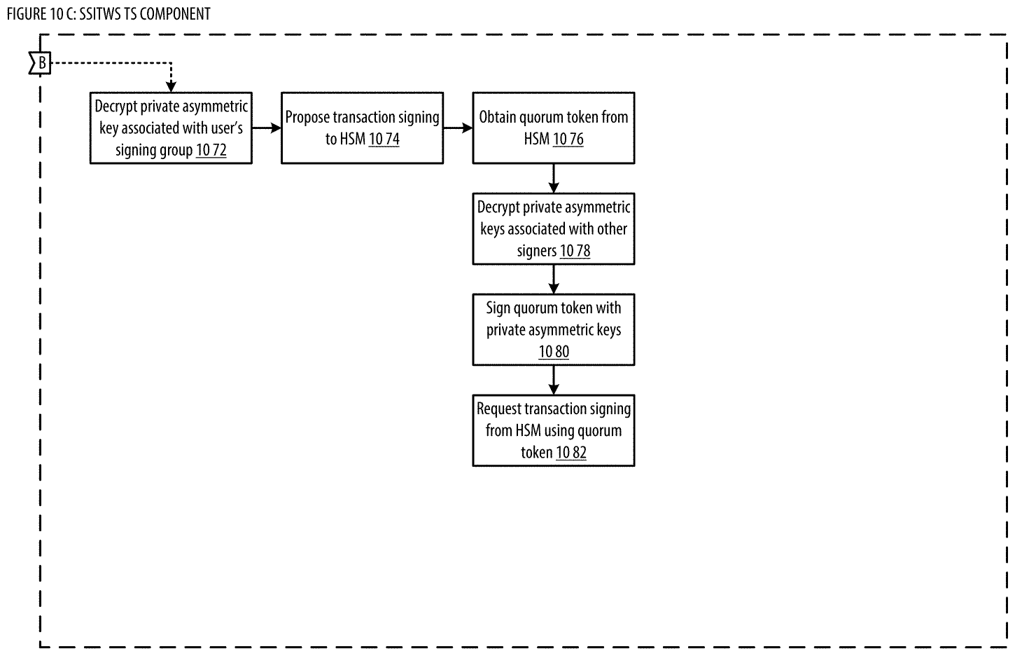

A transaction signing (TS) component 929 may utilize data provided in the transaction signing request to facilitate signing the transfer transaction. See FIGS. 10A-C for additional details regarding the TS component.

The vault server 910 may send an authentication request 933 to an authentication server 918 (e.g., Azure Active Directory) to facilitate determining whether the user is authorized to sign the transaction. In one implementation, the authentication request may include data such as a request identifier, a user identifier, authentication data, and/or the like. In one embodiment, the vault server may provide the following example authentication request, substantially in the form of a HTTP(S) POST message including XML-formatted data, as provided below:

```
POST /authentication_request.php HTTP/1.1
Host: www.server.com
Content-Type: Application/XML
Content-Length: 667
<?XML version = “1.0” encoding = “UTF-8”?>
<authentication_request>
  <request_identifier>ID_request_13</request_identifier>
  <user_identifier>ID_user_1</user_identifier>
  <first_authentication_data>password1</first_authentication_data>
  <second_authentication_data>pin1</second_authentication_data>
</authentication_request>
```

The authentication server 918 may send an authentication response 937 to the vault server 910 with an authentication token for the authenticated user. In one implementation, the authentication response may include data such as a response identifier, a status, an authentication token, and/or the like. In one embodiment, the authentication server may provide the following example authentication response, substantially in the form of a HTTP(S) POST message including XML-formatted data, as provided below:

```
POST /authentication_response.php HTTP/1.1
Host: www.server.com
Content-Type: Application/XML
Content-Length: 667
<?XML version = “1.0” encoding = “UTF-8”?>
<authentication_response>
  <response_identifier>ID_response_13</response_identifier>
  <status>AUTHENTICATED</status>
  <auth_token>1eyJabGciOiJdUzI1NiJ9...</auth_token>
</authentication_response>
```

The vault server 910 may send an additional transaction signing request 941 to the application server 906 to obtain additional transaction signatures from other signing groups (e.g., from 2 other signing groups for a 3-of-5 approval method) associated with a workflow policy corresponding to the transfer transaction. In one implementation, the additional transaction signing request may include data such as a request identifier, transaction information, signing groups to contact information, and/or the like. In one embodiment, the vault server may provide the following example additional transaction signing request, substantially in the form of a HTTP(S) POST message including XML-formatted data, as provided below:

```
POST /additional_transaction_signing_request.php HTTP/1.1
Host: www.server.com
Content-Type: Application/XML
Content-Length: 667
<?XML version = “1.0” encoding = “UTF-8”?>
<additional_transaction_signing_request>
  <request_identifier>ID_request_14</request_identifier>
  <transaction_information>
    <initiated_by>ID_user_1</initiated_by>
    <transaction_identifier>ID_transaction_1</transaction_identifier>
    <transaction_type>TRANSFER</transaction_type>
    <wallet_identifier>555</wallet_identifier>
    <wallet_name>BTC Testnet Wallet</wallet_name>
    <asset_type>BTC</asset_type>
    <transaction_amount>1</transaction_amount>
    <recipient_address>mkv...1Lf</recipient_address>
  </transaction_information>
  <signing_groups_to_contact>
    <group>
      <group_identifier>ID_group_2</group_identifier>
      <authorized_signers_information>
        <user>
          <user_identifier>ID_user_2</user_identifier>
          <name>Bob</name>
          <email>bob@account_address.com</email>
        </user>
        ...
      </authorized_signers_information>
    </group>
    <group>
      <group_identifier>ID_group_3</group_identifier>
      <authorized_signers_information>
        <user>
          <user_identifier>ID_user_6</user_identifier>
          <name>Dave</name>
          <email>dave@account_address.com</email>
        </user>
        ...
      </authorized_signers_information>
    </group>
    ...
  </signing_groups_to_contact>
</additional_transaction_signing_request>
```

The application server 906 may send (e.g., via an application notification, via email) an additional transaction signing request output 945 to other clients 902 (e.g., to clients of users who are authorized signers of the other signing groups associated with the workflow policy) to request additional transaction signatures for the transfer transaction. In one implementation, the additional transaction signing request output may include data such as a request identifier, transaction information, and/or the like. In one embodiment, the application server may provide the following example additional transaction signing request output, substantially in the form of a HTTP(S) POST message including XML-formatted data, as provided below:

```
POST /additional_transaction_signing_request_output.php HTTP/1.1
Host: www.server.com
Content-Type: Application/XML
Content-Length: 667
<?XML version = “1.0” encoding = “UTF-8”?>
<additional_transaction_signing_request_output>
  <request_identifier>ID_request_15</request_identifier>
  <transaction_information>
    <initiated_by>ID_user_1</initiated_by>
    <transaction_identifier>ID_transaction_1</transaction_identifier>
    <transaction_type>TRANSFER</transaction_type>
    <wallet_identifier>555</wallet_identifier>
    <wallet_name>BTC Testnet Wallet</wallet_name>
    <asset_type>BTC</asset_type>
    <transaction_amount>1</transaction_amount>
    <recipient_address>mkv...1Lf</recipient_address>
  </transaction_information>
</additional_transaction_signing_request_output>
```

One of the other clients 902 (e.g., of another user) may send an additional transaction signing response input 949 to the application server 906 to provide an additional transaction signature for the transfer transaction. In one implementation, the additional transaction signing response input may include data such as a response identifier, a response type, a user identifier, authentication data, a transaction identifier, and/or the like. In one embodiment, the clients may provide the following example additional transaction signing response input, substantially in the form of a HTTP(S) POST message including XML-formatted data, as provided below:

```
POST /additional_transaction_signing_response_input.php HTTP/1.1
Host: www.server.com
Content-Type: Application/XML
Content-Length: 667
<?XML version = “1.0” encoding = “UTF-8”?>
<additional_transaction_signing_response_input>
    <response_identifier>ID_response_15</response_identifier>
    <response_type>APPROVE</response_type>
    <user_identifier>ID_user_2</user_identifier>
    <first_authentication_data>password2</first_authentication_data>
    <second_authentication_data>pin2</second_authentication_data>
    <transaction_identifier>ID_transaction_1</transaction_identifier>
</additional_transaction_signing_response_input>
```

The application server 906 may send an additional transaction signing response 953 to the vault server 910 to request that the vault server facilitate signing the transfer transaction. In one implementation, the additional transaction signing response may include data such as a response identifier, a response type, a user identifier, authentication data, a transaction identifier, and/or the like. In one embodiment, the application server may provide the following example additional transaction signing response, substantially in the form of a HTTP(S) POST message including XML-formatted data, as provided below:

```
POST /additional_transaction_signing_response.php HTTP/1.1
Host: www.server.com
Content-Type: Application/XML
Content-Length: 667
<?XML version = “1.0” encoding = “UTF-8”?>
<additional_transaction_signing_response>
    <response_identifier>ID_response_14</response_identifier>
    <response_type>APPROVE</response_type>
    <user_identifier>ID_user_2</user_identifier>
    <first_authentication_data>password2</first_authentication_data>
    <second_authentication_data>pin2</second_authentication_data>
    <transaction_identifier>ID_transaction_1</transaction_identifier>
</additional_transaction_signing_response>
```

The vault server 910 may send an authentication request 957 to the authentication server 918 to facilitate determining whether the other user is authorized to sign the transaction. In one implementation, the authentication request may include data such as a request identifier, a user identifier, authentication data, and/or the like. In one embodiment, the vault server may provide the following example authentication request, substantially in the form of a HTTP(S) POST message including XML-formatted data, as provided below:

```
POST /authentication_request.php HTTP/1.1
Host: www.server.com
Content-Type: Application/XML
Content-Length: 667
<?XML version = “1.0” encoding = “UTF-8”?>
<authentication_request>
    <request_identifier>ID_request_16</request_identifier>
    <user_identifier>ID_user_2</user_identifier>
    <first_authentication_data>password2</first_authentication_data>
    <second_authentication_data>pin2</second_authentication_data>
</authentication_request>
```

The authentication server 918 may send an authentication response 961 to the vault server 910 with an authentication token for the other authenticated user. In one implementation, the authentication response may include data such as a response identifier, a status, an authentication token, and/or the like. In one embodiment, the authentication server may provide the following example authentication response, substantially in the form of a HTTP(S) POST message including XML-formatted data, as provided below:

```
POST /authentication_response.php HTTP/1.1
Host: www.server.com
Content-Type: Application/XML
Content-Length: 667
<?XML version = “1.0” encoding = “UTF-8”?>
<authentication_response>
    <response_identifier>ID_response_16</response_identifier>
    <status>AUTHENTICATED</status>
    <auth_token>2eyJabGciOiJdUzI1NiJ9...</auth_token>
</authentication_response>
```

The vault server 910 may send a transaction signing request message 965 to an HSM 914 to facilitate transaction signing. In one implementation, the transaction signing request message may include data such as a request identifier, a request type, an HSM wallet identifier, an asymmetric private key (e.g., for the workflow policy corresponding to the transfer transaction), a transaction hash, and/or the like. In one embodiment, the vault server may provide the following example transaction signing request message, substantially in the form of a HTTP(S) POST message including XML-formatted data, as provided below:

```
POST /transaction_signing_request_message.php HTTP/1.1
Host: www.server.com
Content-Type: Application/XML
Content-Length: 667
<?XML version = “1.0” encoding = “UTF-8”?>
<transaction_signing_request_message>
    <request_identifier>ID_request_17</request_identifier>
    <request_type>SIGN_TRANSACTION</request_type>
    <HSM_wallet_identifier>123-456-789</HSM_wallet_identifier>
    <access_key>asymmetric private key</access_key>
    <transaction_hash>hash of the transaction</transaction_hash>
</transaction_signing_request_message>
```

The HSM 914 may send a transaction signing response message 969 to the vault server 910 with a signed transaction hash. In one implementation, the transaction signing response message may include data such as a response identifier, the signed transaction hash, and/or the like. In one embodiment, the HSM may provide the following example transaction signing response message, substantially in the form of a HTTP(S) POST message including XML-formatted data, as provided below:

```
POST /transaction_signing_response_message.php HTTP/1.1
Host: www.server.com
Content-Type: Application/XML
Content-Length: 667
<?XML version = “1.0” encoding = “UTF-8”?>
<transaction_signing_response_message>
    <response_identifier>ID_response_17</response_identifier>
    <signed_transaction_hash>
        hash of the transaction signed with the wallet's private key
    </signed_transaction_hash>
</transaction_signing_response_message>
```

The vault server 910 may send a transaction signing response 973 to the application server 906 to confirm that the transaction was signed successfully. In one implementation, the transaction signing response may include data such as a response identifier, the signed transaction hash, a status, and/or the like. In one embodiment, the vault server may provide the following example transaction signing response, substantially in the form of a HTTP(S) POST message including XML-formatted data, as provided below:

```
POST /transaction_signing_response.php HTTP/1.1
Host: www.server.com
Content-Type: Application/XML
Content-Length: 667
<?XML version = “1.0” encoding = “UTF-8”?>
<transaction_signing_response>
    <response_identifier>ID_response_12</response_identifier>
    <signed_transaction_hash>
        hash of the transaction signed with the wallet's private key
    </signed_transaction_hash>
    <status>OK</status>
</transaction_signing_response>
```

The application server 906 may send a transaction signing response output 977 to the client of the user 902 to inform the user that the transaction was signed successfully. In one implementation, the transaction signing response output may include data such as a response identifier, the signed transaction hash, a status, and/or the like. In one embodiment, the application server may provide the following example transaction signing response output, substantially in the form of a HTTP(S) POST message including XML-formatted data, as provided below:

```
POST /transaction_signing_response_output.php HTTP/1.1
Host: www.server.com
Content-Type: Application/XML
Content-Length: 667
<?XML version = “1.0” encoding = “UTF-8”?>
<transaction_signing_response_output>
    <response_identifier>ID_response_11</response_identifier>
    <signed_transaction_hash>
        hash of the transaction signed with the wallet's private key
    </signed_transaction_hash>
    <status>OK</status>
</transaction_signing_response_output>
```

FIGS. 10A-C show a logic flow illustrating embodiments of a transaction signing (TS) component for the SSITWS. In FIG. 10A, a transaction signing request may be obtained at 1001. For example, the transaction signing request may be obtained as a result of a user request to sign a transaction associated with a cryptographic wallet.

A wallet identifier of the cryptographic wallet may be determined at 1005. In one implementation, the transaction signing request may be parsed (e.g., using PHP commands) to determine the wallet identifier (e.g., based on the value of the wallet_identifier field). In another implementation, an HSM wallet identifier may be determined. For example, the HSM wallet identifier may be determined via a MySQL database command similar to the following:
SELECT walletID_providedByHSM
FROM Wallets
WHERE walletID=555;

A transaction amount may be determined at 1009. For example, the transaction amount may be an amount to transfer to another address. In another example, the transaction amount may be an amount to use for staking In one implementation, the transaction signing request may be parsed (e.g., using PHP commands) to determine the transaction amount (e.g., based on the value of the transaction_amount field and/or asset_type field).

A transaction recipient address may be determined at 1013. For example, the transaction recipient address may be an address to which to transfer assets. In another example, the transaction recipient address may be an address used for staking (e.g., to receive payments). In one implementation, the transaction signing request may be parsed (e.g., using PHP commands) to determine the transaction recipient address (e.g., based on the value of the recipient_address field).

A workflow policy associated with the transaction may be determined at 1015. In one implementation, rules of workflow policies associated with the cryptographic wallet may be checked against transaction parameters to determine the workflow policy that corresponds to the transaction. For example, the workflow policy associated with the transaction may be determined via a MySQL database command similar to the following:

```
SELECT workflowPolicyID
FROM Policies
WHERE workflowPolicyLinkedWalletID = 555 AND
    workflowPolicyAddressWhitelist IN (transaction recipient address)
    AND
    workflowPolicyMinAmountThreshold <= transaction amount AND
    workflowPolicyMaxAmountThreshold >= transaction amount;
```

A signing group associated with the requesting user may be determined at 1017. In one implementation, the workflow policy's signing groups may be analyzed (e.g., based on the workflowPolicySigningGroupsConfiguration database field data) to determine the signing group that includes the user as an authorized signer (e.g., via one or more SQL statements).

A determination may be made at 1021 whether the user is authorized to sign the transaction. In one embodiment, the user is authorized to sign the transaction if an authentication server authenticated the user and the user is an authorized signer of a signing group associated with a workflow policy that corresponds to the transaction. If the user is not authorized, the request may be rejected at 1025. For example, the user may be informed that the user is not authorized to invoke the transaction.

If the user is authorized, the number of signatures utilized for transaction approval may be determined at 1029. In one implementation, rules of the associated workflow policy may be checked to determine the number of signatures utilized for transaction approval. For example, the number of signatures utilized for transaction approval may be determined via a MySQL database command similar to the following:
SELECT workflowPolicyMinNumberSignatures
FROM Policies
WHERE workflowPolicyID=identifier of the associated workflow policy;

A determination may be made at 1033 whether there remain signing groups to contact. In one implementation, each of the signing groups associated with the workflow policy, except the signing group associated with the user, may be contacted (e.g., when any authorized signer may provide an approval signature for a signing group). In another implementation, each of the signing groups associated with the workflow policy may be contacted (e.g., when multiple (e.g., any two) authorized signers have to provide approval signatures for a signing group). If there remain signing groups to contact, the next signing group may be selected at 1037.

Transaction approval may be requested from authorized signers of the selected signing group at 1041. In one implementation, authorized signers of the selected signing group may be contacted (e.g., via an application notification, via email) and requested to approve the transaction.

A determination may be made at 1043 whether approvals for the transaction have been received (e.g., within a specified time frame). For example, if the number of signatures utilized for transaction approval is 3 (e.g., for a 3-of-5 approval method) and the user provided the first signature, signatures from 2 other signing groups would have to be received (e.g., within 1 hour of the transaction signing request). If approvals have not been received, the request may be rejected at 1025. For example, the user may be informed that approvals for the transaction have not been received.

If approvals have been received, a transaction signature with the cryptographic wallet's private key for the transaction may be obtained from an HSM at 1045. In one embodiment, asymmetric private key shards may be utilized for transaction signing. See FIG. 10B for additional details regarding this embodiment. In another embodiment, a set of asymmetric private keys may be utilized for transaction signing. See FIG. 10C for additional details regarding this embodiment.

The signed transaction may be provided at 1049. For example, a hash of the transaction signed with the cryptographic wallet's private key may be provided. In one implementation, the signed transaction may be provided to the user. In another implementation, the signed transaction may be broadcast to a blockchain network (e.g., Bitcoin testnet).

FIG. 10B shows a logic flow illustrating embodiments of a transaction signing (TS) component for the SSITWS. In FIG. 10B, an asymmetric private key shard associated with the user's signing group may be decrypted at 1052. In one implementation, the asymmetric private key shard associated with the user's signing group may be decrypted based on receiving an authorization from the user and/or other authorized signers in the user's signing group.

Asymmetric private key shards associated with other authorized signers may be decrypted at 1054. For example, if signatures from 2 other signing groups have been received, asymmetric private key shards associated with these other signing groups may be decrypted. In one implementation, an asymmetric private key shard associated with a signing group may be decrypted based on receiving an authorization from one or more authorized signers of the signing group.

An asymmetric private key for accessing the HSM may be constructed from the decrypted key shards at 1056. In one implementation, Shamir secret sharing (SSS) cryptographic method may be utilized to recreate the asymmetric private key from the decrypted key shards. For example, if the workflow policy is configured to utilize 3-of-5 approval method, 3 shards would be used to recreate the asymmetric private key.

Transaction signing may be requested from the HSM using the constructed asymmetric private key at 1058. In one implementation, a transaction signing request message may be sent to the HSM. For example, the HSM may utilize a registered asymmetric public key to verify that the asymmetric private key allows requesting transaction signing.

FIG. 10C shows a logic flow illustrating embodiments of a transaction signing (TS) component for the SSITWS. In FIG. 10B, an asymmetric private key associated with the user's signing group may be decrypted at 1072. In one implementation, the asymmetric private key associated with the user's signing group may be decrypted based on receiving an authorization from the user and/or other authorized signers in the user's signing group.

Transaction signing may be proposed to the HSM at 1074. In one implementation, a hash of the transaction may be generated and provided to the HSM with a proposal to sign the transaction. In response to the proposal, a quorum token for transaction signing may be obtained from the HSM at 1076.

Asymmetric private keys associated with other authorized signers may be decrypted at 1078. For example, if signatures from 2 other signing groups have been received, asymmetric private keys associated with these other signing groups may be decrypted. In one implementation, an asymmetric private key associated with a signing group may be decrypted based on receiving an authorization from one or more authorized signers of the signing group.

The quorum token may be signed with the asymmetric private keys at 1080. In one implementation, the asymmetric private keys (e.g., associated with the user's signing group and the other signing groups) are used to cryptographically sign the quorum token.

Transaction signing may be requested from the HSM using the quorum token at 1082. In one implementation, the signed quorum token may be provided to the HSM. For example, the HSM may utilize M-of-N registered asymmetric public keys to verify that the quorum token is signed with a configured quorum number of signatures, which allows requesting transaction signing.

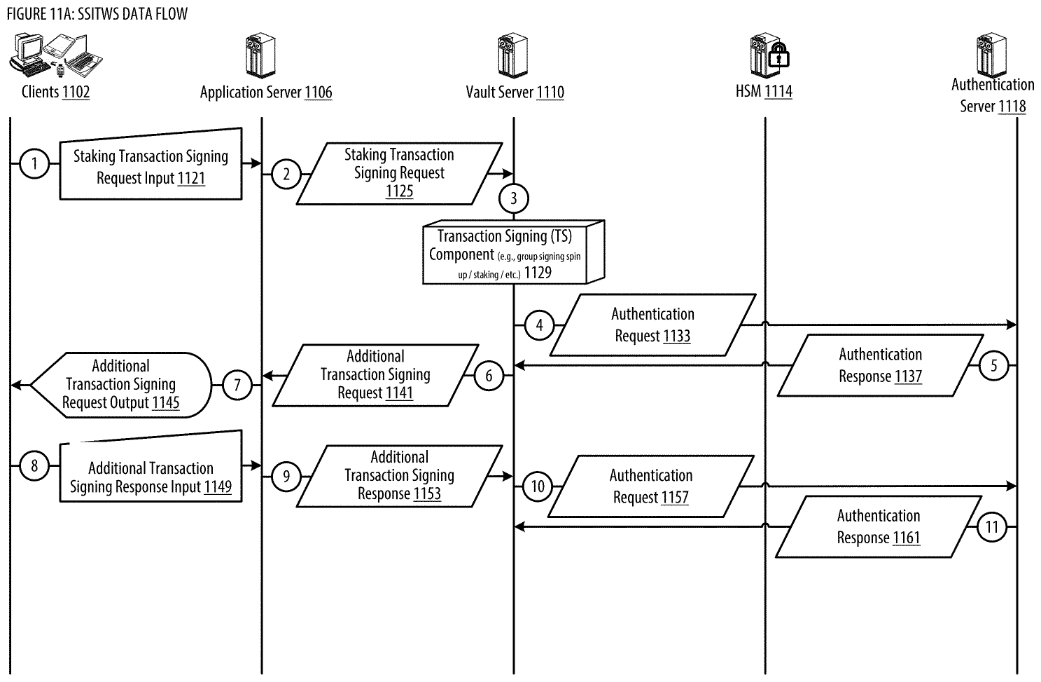

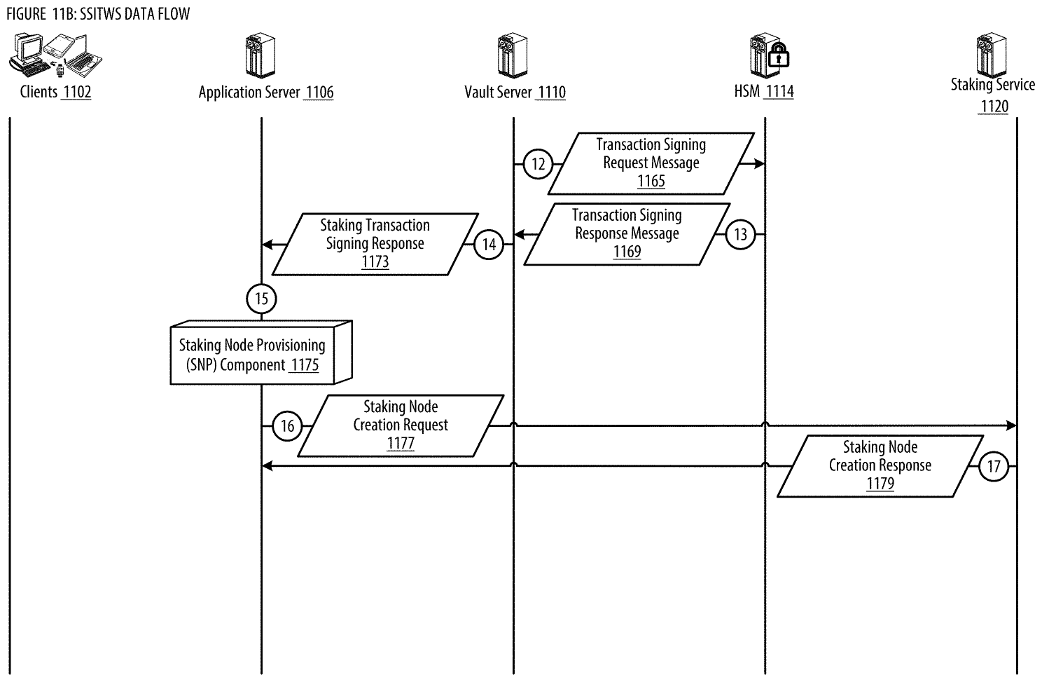

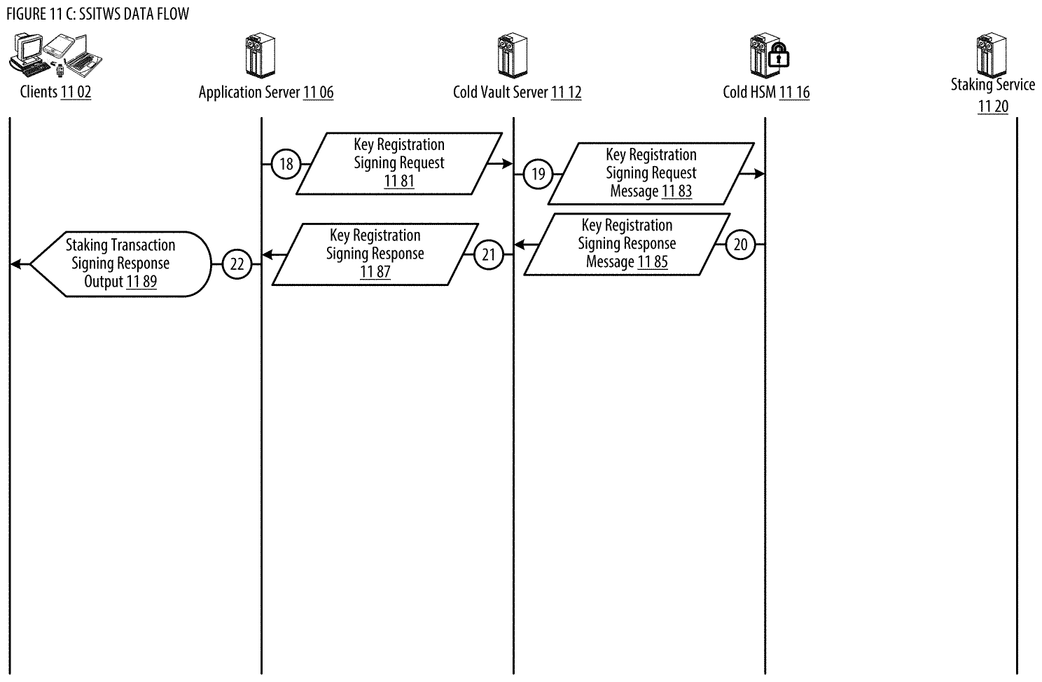

FIGS. 11A-C show a datagraph illustrating data flow(s) for the SSITWS. In FIGS. 11A-C, one of clients 1102 (e.g., of a user) may send a staking transaction signing request input 1121 to an application server 1106 (e.g., running a Rails app) to facilitate signing a staking transaction (e.g., to provision a staking node) associated with a cryptographic wallet. In one implementation, the staking transaction signing request input may include data such as a request identifier, a user identifier, authentication data (e.g., using multi-factor authentication), a transaction identifier, a transaction type, a wallet identifier, an asset type, a transaction amount, a recipient address (e.g., address that will receive staking payments), a node name, a network name, and/or the like. In one embodiment, the clients may provide the following example staking transaction signing request input, substantially in the form of a HTTP(S) POST message including XML-formatted data, as provided below:

```
POST /staking_transaction_signing_request_input.php HTTP/1.1
Host: www.server.com
Content-Type: Application/XML
Content-Length: 667
<?XML version = “1.0” encoding = “UTF-8”?>
<staking_transaction_signing_request_input>
    <request_identifier>ID_request_21</request_identifier>
    <user_identifier>ID_user_1</user_identifier>
    <first_authentication_data>password1</first_authentication_data>
    <second_authentication_data>pin1</second_authentication_data>
    <transaction_identifier>ID_transaction_2</transaction_identifier>
    <transaction_type>STAKE</transaction_type>
    <wallet_identifier>555</wallet_identifier>
    <asset_type>Dash</asset_type>
    <transaction_amount>1000</transaction_amount>
    <recipient_address>mkv...1Lf</recipient_address>
    <node_name>API Masternode</node_name>
    <network_name>testnet</network_name>
</staking_transaction_signing_request_input>
```

The application server 1106 may send a staking transaction signing request 1125 to a vault server 1110 to request that the vault server facilitate signing the staking transaction. In one implementation, the staking transaction signing request may include data such as a request identifier, a user identifier, authentication data (e.g., using multi-factor authentication), a transaction identifier, a transaction type, a wallet identifier, an asset type, a transaction amount, a recipient address (e.g., address that will receive staking payments), a node name, a network name, and/or the like. In one embodiment, the application server may provide the following example staking transaction signing request, substantially in the form of a HTTP(S) POST message including XML-formatted data, as provided below:

```
POST /staking_transaction_signing_request.php HTTP/1.1
Host: www.server.com
Content-Type: Application/XML
Content-Length: 667
<?XML version = “1.0” encoding = “UTF-8”?>
<staking_transaction_signing_request>
    <request_identifier>ID_request_22</request_identifier>
    <user_identifier>ID_user_1</user_identifier>
    <first_authentication_data>password1</first_authentication_data>
    <second_authentication_data>pin1</second_authentication_data>
    <transaction_identifier>ID_transaction_2</transaction_identifier>
    <transaction_type>STAKE</transaction_type>
    <wallet_identifier>555</wallet_identifier>
    <asset_type>Dash</asset_type>
    <transaction_amount>1000</transaction_amount>
    <recipient_address>mkv...1Lf</recipient_address>
    <node_name>API Masternode</node_name>
    <network_name>testnet</network_name>
</staking_transaction_signing_request>
```

A transaction signing (TS) component 1129 may utilize data provided in the staking transaction signing request to facilitate signing the staking transaction. See FIGS. 10A-C for additional details regarding the TS component.

The vault server 1110 may send an authentication request 1133 to an authentication server 1118 (e.g., Azure Active Directory) to facilitate determining whether the user is authorized to sign the transaction. In one implementation, the authentication request may include data such as a request identifier, a user identifier, authentication data, and/or the like. In one embodiment, the vault server may provide the following example authentication request, substantially in the form of a HTTP(S) POST message including XML-formatted data, as provided below:

```
POST /authentication_request.php HTTP/1.1
Host: www.server.com
Content-Type: Application/XML
Content-Length: 667
<?XML version = “1.0” encoding = “UTF-8”?>
<authentication_request>
    <request_identifier>ID_request_23</request_identifier>
    <user_identifier>ID_user_1</user_identifier>
    <first_authentication_data>password1</first_authentication_data>
    <second_authentication_data>pin1</second_authentication_data>
</authentication_request>
```

The authentication server 1118 may send an authentication response 1137 to the vault server 1110 with an authentication token for the authenticated user. In one implementation, the authentication response may include data such as a response identifier, a status, an authentication token, and/or the like. In one embodiment, the authentication server may provide the following example authentication response, substantially in the form of a HTTP(S) POST message including XML-formatted data, as provided below:

```
POST /authentication_response.php HTTP/1.1
Host: www.server.com
Content-Type: Application/XML
Content-Length: 667
<?XML version = “1.0” encoding = “UTF-8”?>
<authentication_response>
    <response_identifier>ID_response_23</response_identifier>
    <status>AUTHENTICATED</status>
    <auth_token>1eyJabGciOiJdUzI1NiJ9...</auth_token>
</authentication_response>
```

The vault server 1110 may send an additional transaction signing request 1141 to the application server 1106 to obtain additional transaction signatures from other signing groups (e.g., from 2 other signing groups for a 3-of-5 approval method) associated with a workflow policy corresponding to the staking transaction. In one implementation, the additional transaction signing request may include data such as a request identifier, transaction information, signing groups to contact information, and/or the like. In one embodiment, the vault server may provide the following example additional transaction signing request, substantially in the form of a HTTP(S) POST message including XML-formatted data, as provided below:

```
POST /additional_transaction_signing_request.php HTTP/1.1
Host: www.server.com
Content-Type: Application/XML
Content-Length: 667
<?XML version = “1.0” encoding = “UTF-8”?>
<additional_transaction_signing_request>
    <request_identifier>ID_request_24</request_identifier>
    <transaction_information>
        <initiated_by>ID_user_1</initiated_by>
        <transaction_identifier>ID_transaction_2
        </transaction_identifier>
        <transaction_type>STAKE</transaction_type>
        <wallet_identifier>555</wallet_identifier>
        <asset_type>Dash</asset_type>
        <transaction_amount>1000</transaction_amount>
        <recipient_address>mkv...1Lf</recipient_address>
        <node_name>API Masternode</node_name>
        <network_name>testnet</network_name>
    </transaction_information>
    <signing_groups_to_contact>
        <group>
            <group_identifier>ID_group_2</group_identifier>
            <authorized_signers_information>
                <user>
                    <user_identifier>ID_user_2</user_identifier>
                    <name>Bob</name>
                    <email>bob@account_address.com</email>
                </user>
                ...
            </authorized_signers_information>
        </group>
        <group>
            <group_identifier>ID_group_3</group_identifier>
            <authorized_signers_information>
                <user>
                    <user_identifier>ID_user_6</user_identifier>
                    <name>Dave</name>
                    <email>dave@account_address.com</email>
                </user>
                ...
            </authorized_signers_information>
        </group>
        ...
    </signing_groups_to_contact>
</additional_transaction_signing_request>
```

The application server 1106 may send an additional transaction signing request output 1145 to other clients 1102 e.g., to clients of users who are authorized signers of the other signing groups associated with the workflow policy) to request additional transaction signatures for the staking transaction. In one implementation, the additional transaction signing request output may include data such as a request identifier, transaction information, and/or the like. In one embodiment, the application server may provide the following example additional transaction signing request output, substantially in the form of a HTTP(S) POST message including XML-formatted data, as provided below:

```
POST /additional_transaction_signing_request_output.php HTTP/1.1
Host: www.server.com
Content-Type: Application/XML
Content-Length: 667
<?XML version = “1.0” encoding = “UTF-8”?>
<additional_transaction_signing_request_output>
    <request_identifier>ID_request_25</request_identifier>
    <transaction_information>
        <initiated_by>ID_user_1</initiated_by>
        <transaction_identifier>ID_transaction_2
        </transaction_identifier>
        <transaction_type>STAKE</transaction_type>
        <wallet_identifier>555</wallet_identifier>
        <asset_type>Dash</asset_type>
        <transaction_amount>1000</transaction_amount>
        <recipient_address>mkv...1Lf</recipient_address>
        <node_name>API Masternode</node_name>
        <network_name>testnet</network_name>
    </transaction_information>
</additional_transaction_signing_request_output>
```

One of the other clients 1102 (e.g., of a user) may send an additional transaction signing response input 1149 to the application server 1106 to provide an additional transaction signature for the staking transaction. In one implementation, the additional transaction signing response input may include data such as a response identifier, a response type, a user identifier, authentication data, a transaction identifier, and/or the like. In one embodiment, the clients may provide the following example additional transaction signing response input, substantially in the form of a HTTP(S) POST message including XML-formatted data, as provided below:

```
POST /additional_transaction_signing_response_input.php HTTP/1.1
Host: www.server.com
Content-Type: Application/XML
Content-Length: 667
<?XML version = “1.0” encoding = “UTF-8”?>
<additional_transaction_signing_response_input>
  <response_identifier>ID_response_25</response_identifier>
  <response_type>APPROVE</response_type>
  <user_identifier>ID_user_2</user_identifier>
  <first_authentication_data>password2</first_authentication_data>
  <second_authentication_data>pin2</second_authentication_data>
  <transaction_identifier>ID_transaction_2</transaction_identifier>
</additional_transaction_signing_response_input>
```

The application server 1106 may send an additional transaction signing response 1153 to the vault server 1110 to request that the vault server facilitate signing the staking transaction. In one implementation, the additional transaction signing response may include data such as a response identifier, a response type, a user identifier, authentication data, a transaction identifier, and/or the like. In one embodiment, the application server may provide the following example additional transaction signing response, substantially in the form of a HTTP(S) POST message including XML-formatted data, as provided below:

```
POST /additional_transaction_signing_response.php HTTP/1.1
Host: www.server.com
Content-Type: Application/XML
Content-Length: 667
<?XML version = “1.0” encoding = “UTF-8”?>
<additional_transaction_signing_response>
  <response_identifier>ID_response_24</response_identifier>
  <response_type>APPROVE</response_type>
  <user_identifier>ID_user_2</user_identifier>
  <first_authentication_data>password2</first_authentication_data>
  <second_authentication_data>pin2</second_authentication_data>
  <transaction_identifier>ID_transaction_2</transaction_identifier>
</additional_transaction_signing_response>
```

The vault server 1110 may send an authentication request 1157 to the authentication server 1118 to facilitate determining whether the other user is authorized to sign the transaction. In one implementation, the authentication request may include data such as a request identifier, a user identifier, authentication data, and/or the like. In one embodiment, the vault server may provide the following example authentication request, substantially in the form of a HTTP(S) POST message including XML-formatted data, as provided below:

```
POST /authentication_request.php HTTP/1.1
Host: www.server.com
Content-Type: Application/XML
Content-Length: 667
<?XML version = “1.0” encoding = “UTF-8”?>
<authentication_request>
  <request_identifier>ID_request_26</request_identifier>
  <user_identifier>ID_user_2</user_identifier>
  <first_authentication_data>password2</first_authentication_data>
  <second_authentication_data>pin2</second_authentication_data>
</authentication_request>
```

The authentication server 1118 may send an authentication response 1161 to the vault server 1110 with an authentication token for the other authenticated user. In one implementation, the authentication response may include data such as a response identifier, a status, an authentication token, and/or the like. In one embodiment, the authentication server may provide the following example authentication response, substantially in the form of a HTTP(S) POST message including XML-formatted data, as provided below:

```
POST /authentication_response.php HTTP/1.1
Host: www.server.com
Content-Type: Application/XML
Content-Length: 667
<?XML version = “1.0” encoding = “UTF-8”?>
<authentication_response>
  <response_identifier>ID_response_26</response_identifier>
  <status>AUTHENTICATED</status>
  <auth_token>2eyJabGci0iJdUzI1NiJ9...</auth_token>
</authentication_response>
```

The vault server 1110 may send a transaction signing request message 1165 to an HSM 1114 to facilitate transaction signing. In one implementation, the transaction signing request message may include data such as a request identifier, a request type, an HSM wallet identifier, an asymmetric private key (e.g., for the workflow policy corresponding to the staking transaction), a transaction hash, and/or the like. In one embodiment, the vault server may provide the following example transaction signing request message, substantially in the form of a HTTP(S) POST message including XML-formatted data, as provided below:

```
POST /transaction_signing_request_message.php HTTP/1.1
Host: www.server.com
Content-Type: Application/XML
Content-Length: 667
<?XML version = “1.0” encoding = “UTF-8”?>
<transaction_signing_request_message>
  <request_identifier>ID_request_27</request_identifier>
  <request_type>SIGN_TRANSACTION</request_type>
  <HSM_wallet_identifier>123-456-789</HSM_wallet_identifier>
  <access_key>asymmetric private key</access_key>
  <transaction_hash>hash of the staking transaction</transaction_hash>
</transaction_signing_request_message>
```

The HSM 1114 may send a transaction signing response message 1169 to the vault server 1110 with a signed transaction hash. In one implementation, the transaction signing response message may include data such as a response identifier, the signed transaction hash, and/or the like. In one embodiment, the HSM may provide the following example transaction signing response message, substantially in the form of a HTTP(S) POST message including XML-formatted data, as provided below:

```
POST /transaction_signing_response_message.php HTTP/1.1
Host: www.server.com
Content-Type: Application/XML
Content-Length: 667
<?XML version = “1.0” encoding = “UTF-8”?>
<transaction_signing_response_message>
  <response_identifier>ID_response_27</response_identifier>
  <signed_transaction_hash>
    hash of the staking transaction signed with the wallet's private key
  </signed_transaction_hash>
</transaction_signing_response_message>
```

The vault server 1110 may send a staking transaction signing response 1173 to the application server 1106 to confirm that the transaction was signed successfully. In one implementation, the staking transaction signing response may include data such as a response identifier, the signed transaction hash, a status, and/or the like. In one embodiment, the vault server may provide the following example staking transaction signing response, substantially in the form of a HTTP(S) POST message including XML-formatted data, as provided below:

```
POST /staking_transaction_signing_response.php HTTP/1.1
Host: www.server.com
Content-Type: Application/XML
Content-Length: 667
<?XML version = “1.0” encoding = “UTF-8”?>
<staking_transaction_signing_response>
  <response_identifier>ID_response_22</response_identifier>
  <signed_transaction_hash>
    hash of the staking transaction signed with the wallet's private key
  </signed_transaction_hash>
  <status>OK</status>
</staking_transaction_signing_response>
```

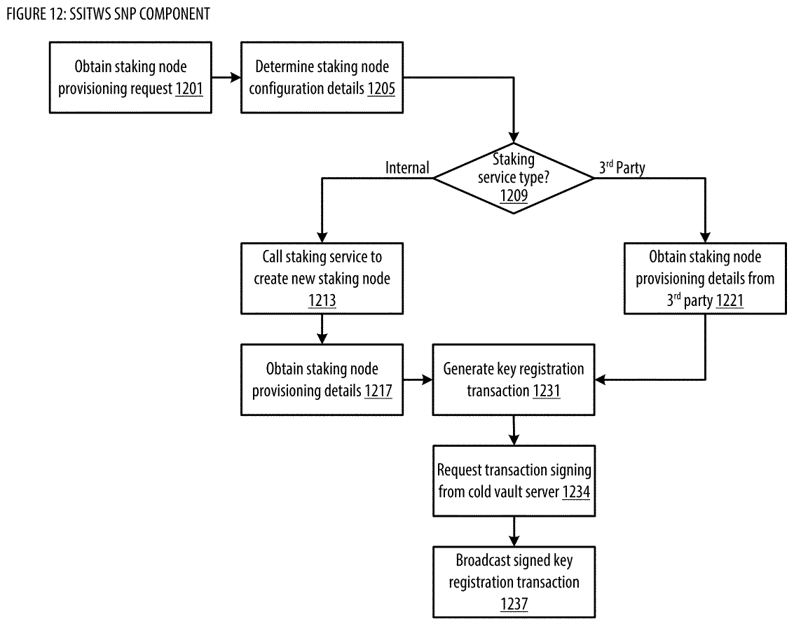

A staking node provisioning (SNP) component 1175 may utilize data provided in the staking transaction signing request input to facilitate provisioning a staking node. See FIG. 12 for additional details regarding the SNP component.

The application server 1106 may send a staking node creation request 1177 to a staking service 1120 (e.g., an internal staking service, a 3^{rd} party staking service) to facilitate provisioning a staking node (e.g., a Dash masternode). In one implementation, the staking node creation request may include data such as a request identifier, a node name, a network name, and/or the like. In one embodiment, the application server may provide the following example staking node creation request, substantially in the form of a HTTP(S) POST message including XML-formatted data, as provided below:

```
POST /staking_node_creation_request.php HTTP/1.1
Host: www.server.com
Content-Type: Application/XML
Content-Length: 667
<?XML version = “1.0” encoding = “UTF-8”?>
<staking_node_creation_request>
  <request_identifier>ID_request_28</request_identifier>
  <node_name>API Masternode</node_name>
  <network_name>testnet</network_name>
</staking_node_creation_request>
```

The staking service 1120 may send a staking node creation response 1179 to the application server 1106 with staking node provisioning information. In one implementation, the staking node creation response may include data such as a response identifier, a node identifier, a node name, a network name, a status, an IP address, an operator key (e.g., a BLS public key of staking node operator, a participation key), and/or the like. In one embodiment, the staking service may provide the following example staking node creation response, substantially in the form of a HTTP(S) POST message including XML-formatted data, as provided below:

```
POST /staking_node_creation_response.php HTTP/1.1
Host: www.server.com
Content-Type: Application/XML
Content-Length: 667
<?XML version = “1.0” encoding = “UTF-8”?>
<staking_node_creation_response>
  <response_identifier>ID_response_28</response_identifier>
  <node_identifier>dm3wsnxcaqmdyr</node_identifier>
  <node_name>API Masternode</node_name>
  <network_name>testnet</network_name>
  <status>pending_registration</status>
  <IP_address>35.247.17.54:9999</IP_address>
  <operator_key>0e5...4b5</operator_key>
</staking_node_creation_response>
```

The application server 1106 may send (e.g., via a USB flash drive) a key registration signing request 1181 to a cold vault server 1112 to request that the cold vault server facilitate signing a key registration transaction. In one implementation, the key registration signing request may include data such as a request identifier, a request type, an owner key (e.g., a public key of staking node owner), the signed staking transaction hash, a node identifier, an operator key, and/or the like. In one embodiment, the application server may provide the following example key registration signing request, substantially in the form of a HTTP(S) POST message including XML-formatted data, as provided below:

```
POST /key_registration_signing_request.php HTTP/1.1
Host: www.server.com
Content-Type: Application/XML
Content-Length: 667
<?XML version = “1.0” encoding = “UTF-8”?>
<key_registration_signing_request>
  <request_identifier>ID_request_29</request_identifier>
  <request_type>KEY_REGISTRATION</request_type>
  <owner_key>owner's public key</owner_key>
  <signed_transaction_hash>
    hash of the staking transaction signed with the wallet's private key
  </signed_transaction_hash>
  <node_identifier>dm3wsnxcaqmdyr</node_identifier>
  <operator_key>0e5...4b5</operator_key>
</key_registration_signing_request>
```

The cold vault server 1112 may send a key registration signing request message 1183 to a cold HSM 1116 to facilitate staking key registration transaction signing. In one implementation, the key registration signing request message may include data such as a request identifier, a request type, an asymmetric private key (e.g., for a workflow policy corresponding to approving key registration transactions by a SSITWS administrator), a key registration transaction hash, and/or the like. In one embodiment, the cold vault server may provide the following example key registration signing request message, substantially in the form of a HTTP(S) POST message including XML-formatted data, as provided below:

```
POST /key_registration_signing_request_message.php HTTP/1.1
Host: www.server.com
Content-Type: Application/XML
Content-Length: 667
<?XML version = “1.0” encoding = “UTF-8”?>
<key_registration_signing_request_message>
  <request_identifier>ID_request_30</request_identifier>
  <request_type>SIGN_TRANSACTION</request_type>
  <access_key>asymmetric private key allowing access to the cold
  HSM</access_key>
  <transaction_hash>hash of the key registration
  transaction</transaction_hash>
</key_registration_signing_request_message>
```

The cold HSM 1116 may send a key registration signing response message 1185 to the cold vault server 1112 with a signed key registration transaction hash. In one implementation, the key registration signing response message may include data such as a response identifier, the signed transaction hash, and/or the like. In one embodiment, the cold HSM may provide the following example key registration signing response message, substantially in the form of a HTTP(S) POST message including XML-formatted data, as provided below:

```
POST /key_registration_signing_response_message.php HTTP/1.1
Host: www.server.com
Content-Type: Application/XML
Content-Length: 667
<?XML version = “1.0” encoding = “UTF-8”?>
<key_registration_signing_response_message>
  <response_identifier>ID_response_30</response_identifier>
  <signed_transaction_hash>
    hash of the key registration transaction signed with
    SSITWS administrator's private key
  </signed_transaction_hash>
</key_registration_signing_response_message>
```

The cold vault server 1112 may send (e.g., via a USB flash drive) a key registration signing response 1187 to the application server 1106 to confirm that the key registration transaction was signed successfully. In one implementation, the key registration signing response may include data such as a response identifier, the signed transaction hash, a status, and/or the like. In one embodiment, the cold vault server may provide the following example key registration signing response, substantially in the form of a HTTP(S) POST message including XML-formatted data, as provided below:

```
POST /key_registration_signing_response.php HTTP/1.1
Host: www.server.com
Content-Type: Application/XML
Content-Length: 667
<?XML version = “1.0” encoding = “UTF-8”?>
<key_registration_signing_response>
  <response_identifier>ID_response_29</response_identifier>
  <signed_transaction_hash>
    hash of the key registration transaction signed with
    SSITWS administrator's private key
  </signed_transaction_hash>
  <status>OK</status>
</key_registration_signing_response>
```

The application server 1106 may send a staking transaction signing response output 1189 to the client of the user 1102 to inform the user that the staking node was provisioned successfully. In one implementation, the staking transaction signing response output may include data such as a response identifier, a status, and/or the like. In one embodiment, the application server may provide the following example staking transaction signing response output, substantially in the form of a HTTP(S) POST message including XML-formatted data, as provided below:

```
POST /staking_transaction_signing_response_output.php HTTP/1.1
Host: www.server.com
Content-Type: Application/XML
Content-Length: 667
<?XML version = “1.0” encoding = “UTF-8”?>
<staking_transaction_signing_response_output>
  <response_identifier>ID_response_21</response_identifier>
  <status>OK</status>
</staking_transaction_signing_response_output>
```

FIG. 12 shows a logic flow illustrating embodiments of a staking node provisioning (SNP) component for the SSITWS. In FIG. 12, a staking node provisioning request may be obtained at 1201. For example, the staking node provisioning request may be obtained as a result of a user sending a staking transaction signing request input to request provisioning of a staking node.

Staking node configuration details may be determined at 1205. For example, the staking node configuration details may include a node name, a node network, and/or the like. In one implementation, the staking node provisioning request may be parsed (e.g., using PHP commands) to determine the staking node configuration details (e.g., based on the values of the node_name, network_name, etc. fields).

A determination may be made at 1209 regarding staking service type to utilize. If an internal staking service is utilized, the internal staking service may be called (e.g., via a staking node creation request) to create a new staking node at 1213. Staking node provisioning details may be obtained (e.g., via a staking node creation response) from the internal staking service at 1217. If a 3^{rd} party staking service is utilized, staking node provisioning details may be obtained (e.g., via a notification, API call, etc.) from the 3^{rd} party staking service at 1221.

A key registration transaction may be generated at 1231. For example, the key registration transaction may specify the operator public key for the staking node and/or a signed hash confirming user authorization of the staking transaction. In one implementation, a key registration signing request may be generated. Key registration transaction signing may be requested from a cold vault server at 1234. In one implementation, the key registration transaction is signed by a SSITWS administrator using a cold HSM associated with the cold vault server.

The signed key registration transaction may be broadcast to a blockchain network (e.g., Dash testnet) at 1237. In one implementation, a hash of the key registration transaction signed with the SSITWS administrator's private key may be broadcast.

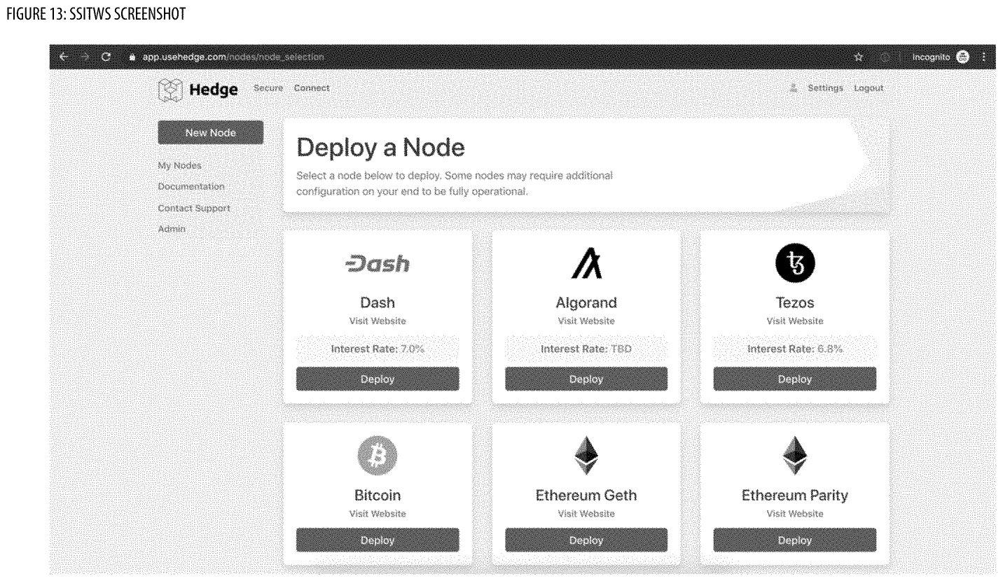

FIG. 13 shows a screenshot illustrating user interface(s) of the SSITWS. In FIG. 13, an exemplary user interface (e.g., for a mobile device, for a website) for selecting a staking node to deploy is illustrated.

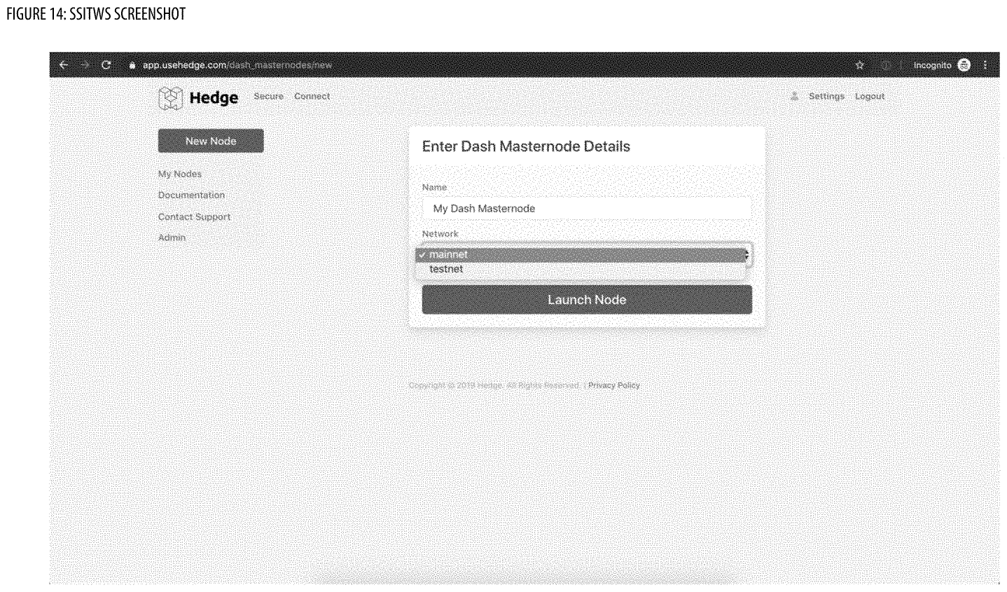

FIG. 14 shows a screenshot illustrating user interface(s) of the SSITWS. In FIG. 14, an exemplary user interface (e.g., for a mobile device, for a website) for selecting a node name and a node network for a staking node is illustrated.

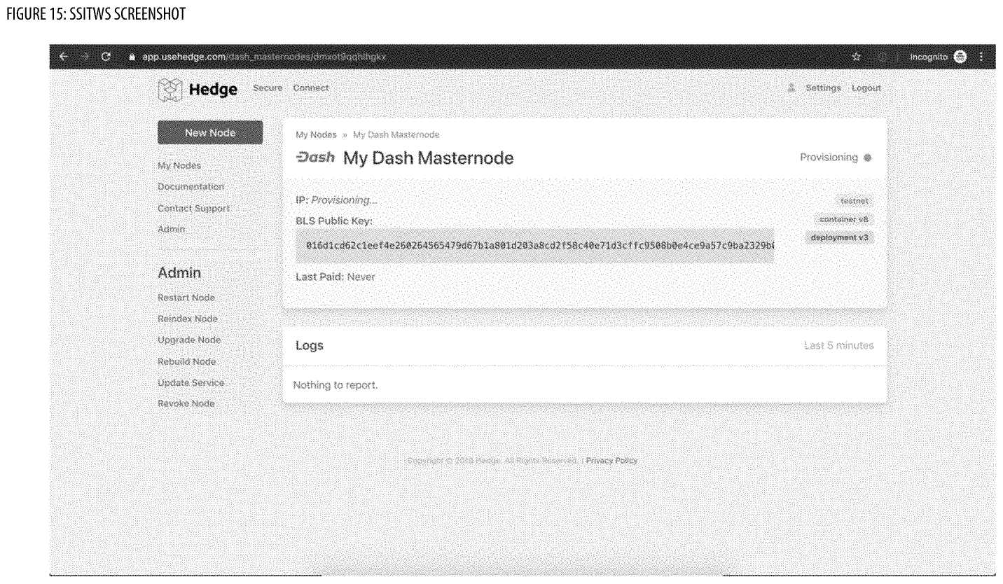

FIG. 15 shows a screenshot illustrating user interface(s) of the SSITWS. In FIG. 15, an exemplary user interface (e.g., for a mobile device, for a website) that shows a BLS Public Key (operator key) for a staking node. The user interface shows that the staking node is still booting and waiting for static IP address to be assigned.

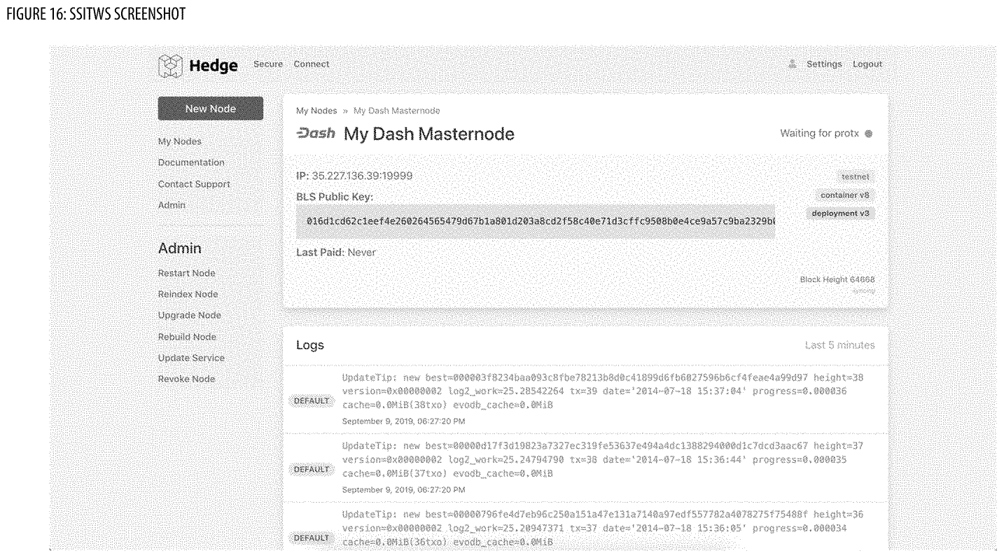

FIG. 16 shows a screenshot illustrating user interface(s) of the SSITWS. In FIG. 16, an exemplary user interface (e.g., for a mobile device, for a website) that shows that the staking node has booted and obtained a static IP address. The user interface shows that the staking node is waiting for on chain key registration transaction to be recognized.

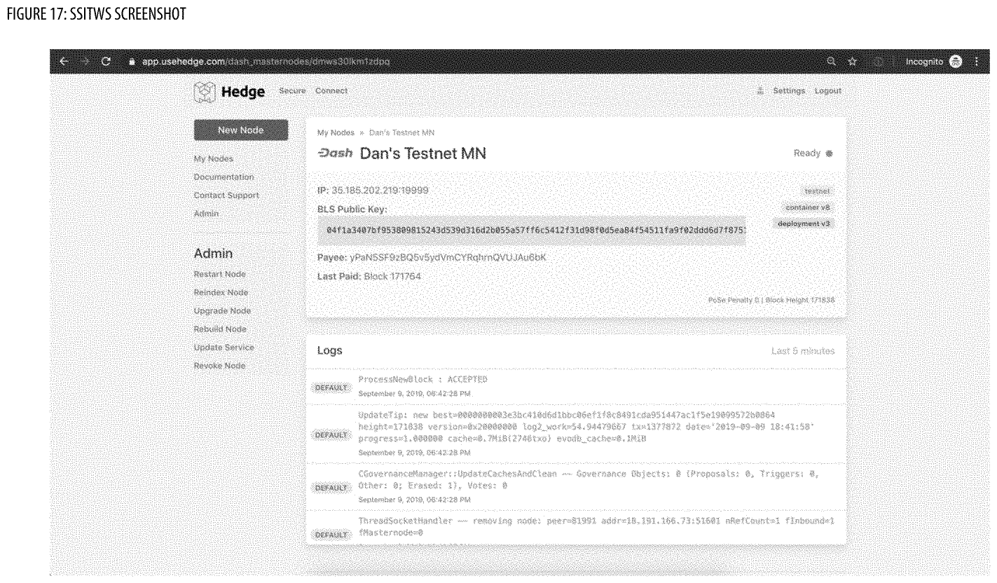

FIG. 17 shows a screenshot illustrating user interface(s) of the SSITWS. In FIG. 17, an exemplary user interface (e.g., for a mobile device, for a website) shows that the key registration transaction has been made. The user interface shows that the staking node (e.g., a Dash masternode) is online and participating with the network.

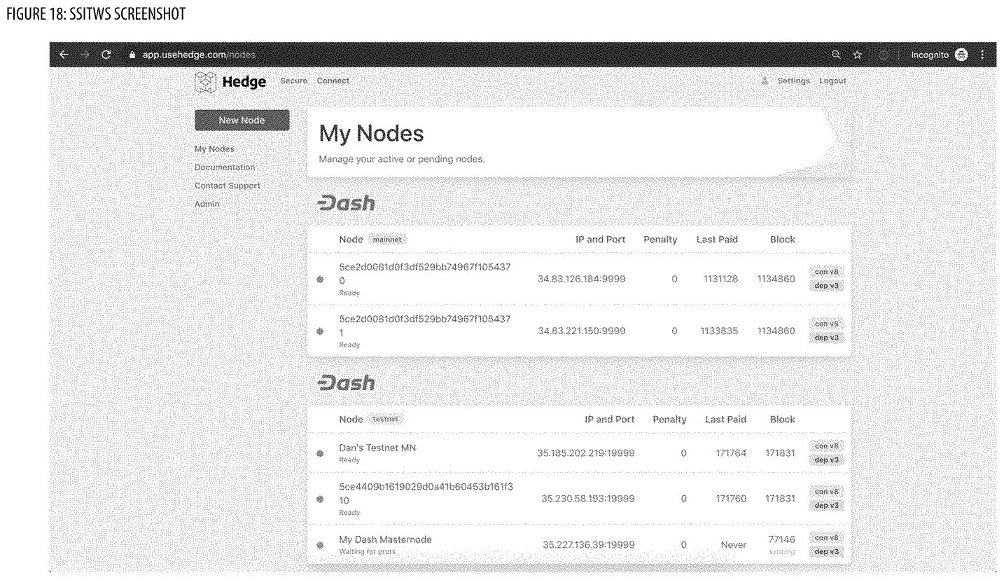

FIG. 18 shows a screenshot illustrating user interface(s) of the SSITWS. In FIG. 18, an exemplary user interface (e.g., for a mobile device, for a website) for providing information regarding staking nodes is illustrated. The user interface shows individual node states (e.g., IP address, current block height, the block when a masternode was last paid, penalty score a masternode has received if operating abnormally).

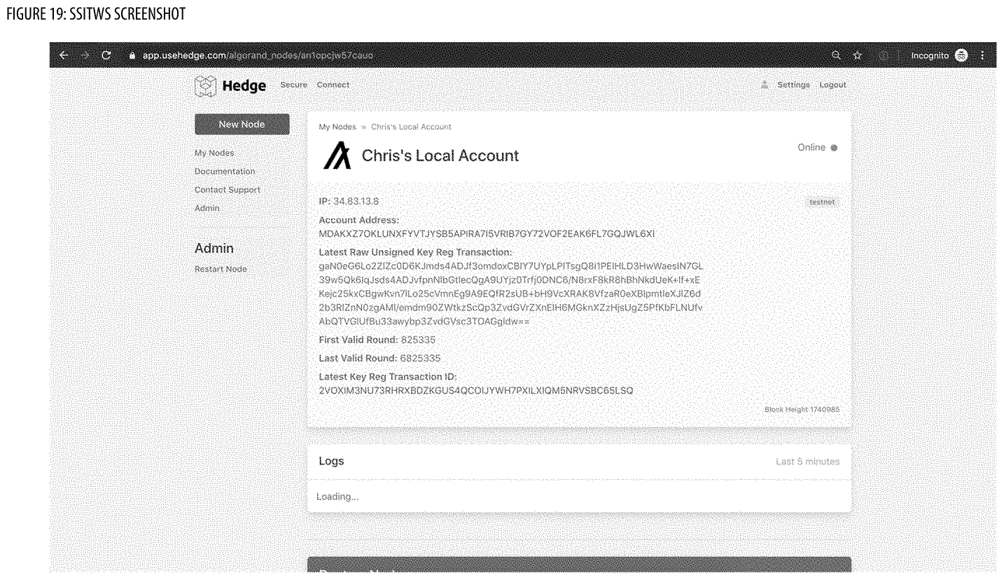

FIG. 19 shows a screenshot illustrating user interface(s) of the SSITWS. In FIG. 19, an exemplary user interface (e.g., for a mobile device, for a website) for providing information regarding a staking node (e.g., an Algorand node) is illustrated. The user interface may show a node's IP address, Algorand Account Address associated with the node, a base64 encoded unsigned key registration transaction which was generated on the node, the first and last block rounds where this node will be valid to participate in the network, and/or the like.

### SSITWS Controller

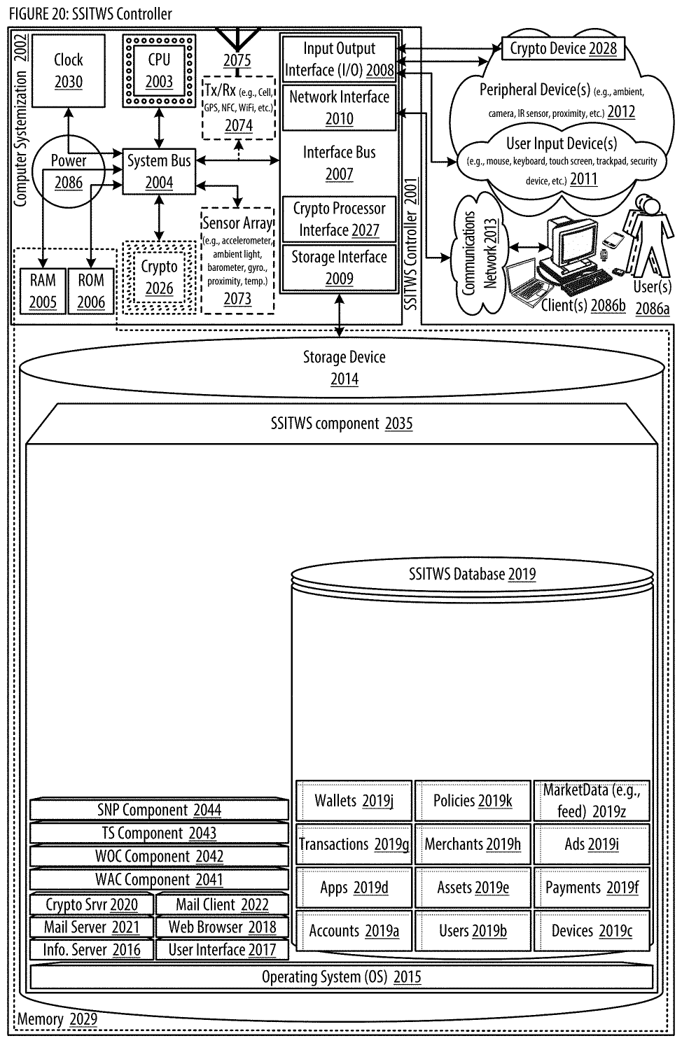

FIG. 20 shows a block diagram illustrating embodiments of a SSITWS controller. In this embodiment, the SSITWS controller 2001 may serve to aggregate, process, store, search, serve, identify, instruct, generate, match, and/or facilitate interactions with a computer through security encryption and management technologies, and/or other related data.

Users, which may be people and/or other systems, may engage information technology systems (e.g., computers) to facilitate information processing. In turn, computers employ processors to process information; such processors 2003 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 2029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SSITWS controller 2001 may be connected to and/or communicate with entities such as, but not limited to: one or more users from peripheral devices 2012 (e.g., user input devices 2011); an optional cryptographic processor device 2028; and/or a communications network 2013.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The SSITWS controller 2001 may be based on computer systems that may comprise, but are not limited to, components such as: a computer systemization 2002 connected to memory 2029.

### Computer Systemization

A computer systemization 2002 may comprise a clock 2030, central processing unit (“CPU(s)” and/or “processor(s)” (these terms are used interchangeable throughout the disclosure unless noted to the contrary)) 2003, a memory 2029 (e.g., a read only memory (ROM) 2006, a random access memory (RAM) 2005, etc.), and/or an interface bus 2007, and most frequently, although not necessarily, are all interconnected and/or communicating through a system bus 2004 on one or more (mother)board(s) 2002 having conductive and/or otherwise transportive circuit pathways through which instructions (e.g., binary encoded signals) may travel to effectuate communications, operations, storage, etc. The computer systemization may be connected to a power source 2086; e.g., optionally the power source may be internal. Optionally, a cryptographic processor 2026 may be connected to the system bus. In another embodiment, the cryptographic processor, transceivers (e.g., ICs) 2074, and/or sensor array (e.g., accelerometer, altimeter, ambient light, barometer, global positioning system (GPS) (thereby allowing SSITWS controller to determine its location), gyroscope, magnetometer, pedometer, proximity, ultra-violet sensor, etc.) 2073 may be connected as either internal and/or external peripheral devices 2012 via the interface bus I/O 2008 (not pictured) and/or directly via the interface bus 2007. In turn, the transceivers may be connected to antenna(s) 2075, thereby effectuating wireless transmission and reception of various communication and/or sensor protocols; for example the antenna(s) may connect to various transceiver chipsets (depending on deployment needs), including: Broadcom® BCM4329FKUBG transceiver chip (e.g., providing 802.11n, Bluetooth 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom® BCM43341 transceiver chip (e.g., providing 2G, 3G and 4G LTE cellular communications; 802.11 g/, Bluetooth 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n, Bluetooth 4.0 LE, FM, GPS; a Lapis Semiconductor® ML8511 UV sensor; a maxim integrated MAX44000 ambient light and infrared proximity sensor; a Texas Instruments® WiLink WL1283 transceiver chip (e.g., providing 802.11n, Bluetooth 3.0, FM, GPS); and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon®, Duron® and/or Opteron®; Apple's® A series of processors (e.g., A5, A6, A7, A8, etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to various data processing techniques. Such instruction passing facilitates communication within the SSITWS controller and beyond through various interfaces. Should processing requirements dictate a greater amount speed and/or capacity, distributed processors (e.g., see Distributed SSITWS below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the SSITWS may be achieved by implementing a microcontroller such as CAST's® R8051XC2 microcontroller; Intel's® MCS 51 (i.e., 8051 microcontroller); and/or the like. Also, to implement certain features of the SSITWS, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SSITWS component collection (distributed or otherwise) and/or features may be implemented via the microprocessor and/or via embedded components; e.g., via ASIC, coprocessor, DSP, FPGA, and/or the like. Alternately, some implementations of the SSITWS may be implemented with embedded components that are configured and used to achieve a variety of features or signal processing.

Depending on the particular implementation, the embedded components may include software solutions, hardware solutions, and/or some combination of both hardware/software solutions. For example, SSITWS features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the SSITWS features. A hierarchy of programmable interconnects allow logic blocks to be interconnected as needed by the SSITWS system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SSITWS may be developed on FPGAs and then migrated into a fixed version that more resembles ASIC implementations. Alternate or coordinating implementations may migrate SSITWS controller features to a final ASIC instead of or in addition to FPGAs. Depending on the implementation all of the aforementioned embedded components and microprocessors may be considered the “CPU” and/or “processor” for the SSITWS.

### Power Source

The power source 2086 may be of any various form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2086 is connected to at least one of the interconnected subsequent components of the SSITWS thereby providing an electric current to all subsequent components. In one example, the power source 2086 is connected to the system bus component 2004. In an alternative embodiment, an outside power source 2086 is provided through a connection across the I/O 2008 interface. For example, a USB and/or IEEE 1394 connection carries both data and power across the connection and is therefore a suitable source of power.

### Interface Adapters

Interface bus(ses) 2007 may accept, connect, and/or communicate to a number of interface adapters, variously although not necessarily in the form of adapter cards, such as but not limited to: input output interfaces (I/O) 2008, storage interfaces 2009, network interfaces 2010, and/or the like. Optionally, cryptographic processor interfaces 2027 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2009 may accept, communicate, and/or connect to a number of storage devices such as, but not limited to: storage devices 2014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2010 may accept, communicate, and/or connect to a communications network 2013. Through a communications network 2013, the SSITWS controller is accessible through remote clients 2033b (e.g., computers with web browsers) by users 2033a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed SSITWS below), architectures may similarly be employed to pool, load balance, and/or otherwise decrease/increase the communicative bandwidth required by the SSITWS controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 2010 may be used to engage with various communications network types 2013. For example, multiple network interfaces may be employed to allow for the communication over broadcast, multicast, and/or unicast networks.

Input Output interfaces (I/O) 2008 may accept, communicate, and/or connect to user, peripheral devices 2012 (e.g., input devices 2011), cryptographic processor devices 2028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may include a video display, which may comprise a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 2012 may be connected and/or communicate to I/O and/or other facilities of the like such as network interfaces, storage interfaces, directly to the interface bus, system bus, the CPU, and/or the like. Peripheral devices may be external, internal and/or part of the SSITWS controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 2011 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the SSITWS controller may be embodied as an embedded, dedicated, and/or monitor-less (i.e., headless) device, wherein access would be provided over a network interface connection.

Cryptographic units such as, but not limited to, microcontrollers, processors 2026, interfaces 2027, and/or devices 2028 may be attached, and/or communicate with the SSITWS controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+ MB/s of cryptographic instructions; VLSI Technology's® 33 MHz 6868; and/or the like.

### Memory

Generally, any mechanization and/or embodiment allowing a processor to affect the storage and/or retrieval of information is regarded as memory 2029. However, memory is a fungible technology and resource, thus, any number of memory embodiments may be employed in lieu of or in concert with one another. It is to be understood that the SSITWS controller and/or a computer systemization may employ various forms of memory 2029. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 2029 will include ROM 2006, RAM 2005, and a storage device 2014. A storage device 2014 may be any various computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 2029 may contain a collection of program and/or database components and/or data such as, but not limited to: operating system component(s) 2015 (operating system); information server component(s) 2016 (information server); user interface component(s) 2017 (user interface); Web browser component(s) 2018 (Web browser); database(s) 2019; mail server component(s) 2021; mail client component(s) 2022; cryptographic server component(s) 2020 (cryptographic server); the SSITWS component(s) 2035; and/or the like (i.e., collectively a component collection). These components may be stored and accessed from the storage devices and/or from storage devices accessible through an interface bus. Although unconventional program components such as those in the component collection may be stored in a local storage device 2014, they may also be loaded and/or stored in memory such as: peripheral devices, RAM, remote storage facilities through a communications network, ROM, various forms of memory, and/or the like.

### Operating System

The operating system component 2015 is an executable program component facilitating the operation of the SSITWS controller. The operating system may facilitate access of I/O, network interfaces, peripheral devices, storage devices, and/or the like. The operating system may be a highly fault tolerant, scalable, and secure system such as: Apple's Macintosh OS X (Server) and macOS®; AT&T Plan 9®; Be OS®; Blackberry's QNX®; Google's Chrome®; Microsoft's Windows® 7/8/10; Unix and Unix-like system distributions (such as AT&T's UNIX®; Berkley Software Distribution (BSD)® variations such as FreeBSD®, NetBSD, OpenBSD, and/or the like; Linux distributions such as Red Hat, Ubuntu, and/or the like); and/or the like operating systems. However, more limited and/or less secure operating systems also may be employed such as Apple Macintosh OS® (i.e., versions 1-9), IBM OS/2®, Microsoft DOS®, Microsoft Windows 2000/2003/3.1/95/98/CE/Millenium/Mobile/NT/Vista/XP (Server)®, Palm OS®, and/or the like. Additionally, for robust mobile deployment applications, mobile operating systems may be used, such as: Apple's iOS®; China Operating System COS®; Google's Android®; Microsoft Windows RT/Phone®; Palm's WebOS®; Samsung/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SSITWS controller to communicate with other entities through a communications network 2013. Various communication protocols may be used by the SSITWS controller as a subcarrier transport mechanism for interaction, such as, but not limited to: multicast, TCP/IP, UDP, unicast, and/or the like.

### Information Server

An information server component 2016 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects®, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SSITWS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SSITWS database 2019, operating systems, other program components, user interfaces, Web browsers, and/or the like.

Access to the SSITWS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SSITWS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, wherein the resulting command is provided over the bridge mechanism to the SSITWS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, menus, scrollers, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface®, any of which may be used and) provide a baseline and means of accessing and displaying information graphically to users.

A user interface component 2017 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2018 is a stored program component that is executed by a CPU. The Web browser may be a hypertext viewing application such as Apple's (mobile) Safari®, Google's Chrome®, Microsoft Internet Explorer®, Mozilla's Firefox®, Netscape Navigator®, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SSITWS enabled nodes. The combined application may be nugatory on systems employing Web browsers.

### Mail Server

A mail server component 2021 is a stored program component that is executed by a CPU 2003. The mail server may be an Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects®, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SSITWS. Alternatively, the mail server component may be distributed out to mail service providing entities such as Google's® cloud services (e.g., Gmail and notifications may alternatively be provided via messenger services such as AOL's Instant Messenger®, Apple's iMessage®, Google Messenger®, SnapChat®, etc.).

Access to the SSITWS mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2022 is a stored program component that is executed by a CPU 2003. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2020 is a stored program component that is executed by a CPU 2003, cryptographic processor 2026, cryptographic processor interface 2027, cryptographic processor device 2028, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the SSITWS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the SSITWS component to engage in secure transactions if so desired. The cryptographic component facilitates the secure accessing of resources on the SSITWS and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SSITWS Database

The SSITWS database component 2019 may be embodied in a database and its stored data. The database is a stored program component, which is executed by the CPU; the stored program component portion configuring the CPU to process the stored data. The database may be a fault tolerant, relational, scalable, secure database such as MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the SSITWS database may be implemented using various other data-structures, such as an array, hash, (linked) list, struct, structured text file (e.g., XML), table, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SSITWS database is implemented as a data-structure, the use of the SSITWS database 2019 may be integrated into another component such as the SSITWS component 2035. Also, the database may be implemented as a mix of data structures, objects, and relational structures. Databases may be consolidated and/or distributed in countless variations (e.g., see Distributed SSITWS below). Portions of databases, e.g., tables, may be exported and/or imported and thus decentralized and/or integrated.

In one embodiment, the database component 2019 includes several tables 2019a-z:

An accounts table 2019a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 2019b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestric Lions, and/or the like (the user table may support and/or track multiple entity accounts on a SSITWS);

An devices table 2019c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_typ e, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

An apps table 2019d includes fields such as, but not limited to: appID, appName, appType, appDependencies, accountID, deviceID s, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;

An assets table 2019e includes fields such as, but not limited to: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, assetAPI, assetAPIconnectionAddress, and/or the like;

A payments table 2019f includes fields such as, but not limited to: paymentID, accountID, userID, couponID, couponValue, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, paymentRestricLions, and/or the like;

An transactions table 2019g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;

An merchants table 2019h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;

An ads table 2019i includes fields such as, but not limited to: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerlP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidlmpressionID, bidType, bidScore, adType (e.g., mobile, desktop, wearable, largescreen, interstitial, etc.), as setID, merchantID, deviceID, userID, accountID, impressionID, impressionOS, impressionTimeStamp, impressionGeo, impressionAction, impressionType, impressionPublisherID, impressionPublisherURL, and/or the like;

A wallets table 2019j includes fields such as, but not limited to: walletID, walletID_providedByHSM, walletCryptographicAssetType, walletNetwork, walletName, walletStatus, walletPublicKey, walletAddress, walletLinkedAccountID, walletLinkedUserIDs, walletCreatedDateTime, walletBalance, and/or the like;

A policies table 2019k includes fields such as, but not limited to: workflowPolicyID, workflowPolicyName, workflowPolicyOperatingHoursConfiguration, workflowPolicyAddressWhitelist, workflowPolicyMinAmountThreshold, workflowPolicyMaxAmountThreshold, workflowPolicyMinNumberSignatures, workflowPolicyNumberSigningGroups, workflowPolicySigningGroupsConfiguration, workflowPolicyLinkedWalletID, and/or the like;

A market_data table 2019z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the SSITWS database may interact with other database systems. For example, employing a distributed database system, queries and data access by search SSITWS component may treat the combination of the SSITWS database, an integrated data security layer database as a single database entity (e.g., see Distributed SSITWS below).

In one embodiment, user programs may contain various user interface primitives, which may serve to update the SSITWS. Also, various accounts may require custom database tables depending upon the environments and the types of clients the SSITWS may need to serve. It should be noted that any unique fields may be designated as a key field throughout. In an alternative embodiment, these tables have been decentralized into their own databases and their respective database controllers (i.e., individual database controllers for each of the above tables). Employing various data processing techniques, one may further distribute the databases over several computer systemizations and/or storage devices. Similarly, configurations of the decentralized database controllers may be varied by consolidating and/or distributing the various database components 2019a-z. The SSITWS may be configured to keep track of various settings, inputs, and parameters via database controllers.

The SSITWS database may communicate to and/or with other components in a component collection, including itself, and/or facilities of the like. Most frequently, the SSITWS database communicates with the SSITWS component, other program components, and/or the like. The database may contain, retain, and provide information regarding other nodes and data.

### The SSITWSs

The SSITWS component 2035 is a stored program component that is executed by a CPU. In one embodiment, the SSITWS component incorporates any and/or all combinations of the aspects of the SSITWS that was discussed in the previous figures. As such, the SSITWS affects accessing, obtaining and the provision of information, services, transactions, and/or the like across various communications networks. The features and embodiments of the SSITWS discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the SSITWS's features and facilities, and in many cases reduce the costs, energy consumption/requirements, and extend the life of SSITWS's underlying infrastructure; this has the added benefit of making the SSITWS more reliable. Similarly, many of the features and mechanisms are designed to be easier for users to use and access, thereby broadening the audience that may enjoy/employ and exploit the feature sets of the SSITWS; such ease of use also helps to increase the reliability of the SSITWS. In addition, the feature sets include heightened security as noted via the Cryptographic components 2020, 2026, 2028 and throughout, making access to the features and data more reliable and secure

The SSITWS transforms cryptographic assets, cryptographic asset addresses, user names, workflow names, workflow conditions, workflow access privileges, wallet conditions, wallet access privileges, transaction signing request inputs, via SSITWS components (e.g., WAC, WOC, TS, SNP), into HSM partition, cryptographic shards, workflow access privileges, wallet access privileges, transaction signing response outputs.

The SSITWS component enabling access of information between nodes may be developed by employing various development tools and languages such as, but not limited to: Apache® components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's® ActiveX; Adobe® AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo!® User Interface; and/or the like), WebObjects®, and/or the like. In one embodiment, the SSITWS server employs a cryptographic server to encrypt and decrypt communications. The SSITWS component may communicate to and/or with other components in a component collection, including itself, and/or facilities of the like. Most frequently, the SSITWS component communicates with the SSITWS database, operating systems, other program components, and/or the like. The SSITWS may contain, communicate, generate, obtain, and/or provide program component, system, user, and/or data communications, requests, and/or responses.

### Distributed SSITWSs

The structure and/or operation of any of the SSITWS node controller components may be combined, consolidated, and/or distributed in any number of ways to facilitate development and/or deployment Similarly, the component collection may be combined in any number of ways to facilitate deployment and/or development. To accomplish this, one may integrate the components into a common code base or in a facility that can dynamically load the components on demand in an integrated fashion. As such a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access).

The component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through various data processing communication techniques.

The configuration of the SSITWS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services®, Microsoft Azure®, Hewlett Packard Helion®, IBM® Cloud services allow for SSITWS controller and/or SSITWS component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RAE), SOAP, process pipes, shared files, and/or the like. Messages sent between discrete component components for inter-application communication or within memory spaces of a singular component for intra-application communication may be facilitated through the creation and parsing of a grammar A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SSITWS controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
    $input = “”;
    $input = socket_read($client, 1024);
    $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:
http://www.xav.com/perl/site/lib/SOAP/Parser.html
http://publib.boulder.ibm.com/infocenter/tivihelp/v2r1/index.jsp?topic=/com.ibm.IBMDI.doc/referenceguide295.htm
   and other parser implementations:
http://publib.boulder.ibm.com/infocenter/tivihelp/v2r1/index.jsp?topic=/com.ibm.IBMDI.doc/referenceguide259.htm
   all of which are hereby expressly incorporated by reference.

Additional embodiments may include:
1. A cryptographic security workflow policy management apparatus, comprising:
a memory;
a component collection in the memory, including:
   a workflow creation component;
a processor disposed in communication with the memory, and configured to issue a plurality of processing instructions from the component collection stored in the memory,
   wherein the processor issues instructions from the workflow creation component, stored in the memory, to:
      obtain, via at least one processor, a workflow creation request datastructure associated with a cryptographic wallet datastructure;
      obtain, via at least one processor, a selection of rules for accessing cryptographic assets associated with the cryptographic wallet datastructure;
      obtain, via at least one processor, a selection of a minimum number of approval signatures utilized for accessing cryptographic assets associated with the cryptographic wallet datastructure;
      obtain, via at least one processor, a selection of signing groups, wherein a signing group is associated with an approval signature, wherein a signing group comprises a set of authorized signers;
      generate, via at least one processor, a set of asymmetric keys associated with the signing groups;
      configure, via at least one processor, access to an individual hardware security module (HSM) partition associated with the cryptographic wallet datastructure using the generated set of asymmetric keys; and
      store, via at least one processor, asymmetric keys data for accessing the individual HSM partition in encrypted security vault data structures, wherein the encrypted security vault data structures are subject to access privileges specified by the selection of rules and the selection of signing groups.
2. The apparatus of embodiment 1, wherein a private key associated with a wallet address specified in the cryptographic wallet datastructure is stored on the individual HSM partition associated with the cryptographic wallet datastructure.
3. The apparatus of embodiment 1, wherein the selection of rules includes a selection of allowable hours of operations.
4. The apparatus of embodiment 1, wherein the selection of rules includes a selection of an address whitelist.
5. The apparatus of embodiment 1, wherein the selection of rules includes a selection of a minimum allowable amount threshold.
6. The apparatus of embodiment 1, wherein the selection of rules includes a selection of a maximum allowable amount threshold.
7. The apparatus of embodiment 1, wherein the selection of signing groups specifies that any authorized signer can provide an approval signature for a signing group.
8. The apparatus of embodiment 1, wherein the selection of signing groups specifies a combination of authorized signers that can provide an approval signature for a signing group.
9. The apparatus of embodiment 1, wherein the selection of signing groups includes at least the minimum number of approval signatures number of signing groups.
10. The apparatus of embodiment 1, wherein the set of asymmetric keys associated with the signing groups comprises one asymmetric public key and a corresponding asymmetric private key.
11. The apparatus of embodiment 10, wherein the instructions to configure access to the individual HSM partition further comprise instructions to:
   register the asymmetric public key with the individual HSM partition;
   create an asymmetric private key shard for each of the signing groups, wherein access to an asymmetric private key shard associated with a signing group is restricted to the signing group; and
   delete the asymmetric private key;
   wherein the asymmetric keys data comprises the created asymmetric private key shards.
12. The apparatus of embodiment 11, wherein the asymmetric private key shards are created using Shamir secret sharing cryptographic method.
13. The apparatus of embodiment 1, wherein the set of asymmetric keys associated with the signing groups comprises an individual asymmetric public key and a corresponding asymmetric private key for each signing group.
14. The apparatus of embodiment 13, wherein the instructions to configure access to the individual HSM partition further comprise instructions to:
   register each of the individual asymmetric public keys with the individual HSM partition; and
   configure the individual HSM partition to grant access based on a quorum number of signatures that is equal to the selected minimum number of approval signatures;
   wherein access to an asymmetric private key associated with a signing group is restricted to the signing group;
   wherein the asymmetric keys data comprises the generated set of asymmetric keys.
15. The apparatus of embodiment 1, wherein at least one signing group is associated with a third-party custodian.
16. The apparatus of embodiment 1, wherein the selection of signing groups specifies authorized signers who should receive staking value.
17. A processor-readable cryptographic security workflow policy management non-transient physical medium storing processor-executable components, the components, comprising:
a component collection stored in the medium, including:
   a workflow creation component;
   wherein the workflow creation component, stored in the medium, includes processor-issuable instructions to:
      obtain, via at least one processor, a workflow creation request datastructure associated with a cryptographic wallet datastructure;
      obtain, via at least one processor, a selection of rules for accessing cryptographic assets associated with the cryptographic wallet datastructure;
      obtain, via at least one processor, a selection of a minimum number of approval signatures utilized for accessing cryptographic assets associated with the cryptographic wallet datastructure;
      obtain, via at least one processor, a selection of signing groups, wherein a signing group is associated with an approval signature, wherein a signing group comprises a set of authorized signers;
      generate, via at least one processor, a set of asymmetric keys associated with the signing groups;
      configure, via at least one processor, access to an individual hardware security module (HSM) partition associated with the cryptographic wallet datastructure using the generated set of asymmetric keys; and
      store, via at least one processor, asymmetric keys data for accessing the individual HSM partition in encrypted security vault data structures, wherein the encrypted security vault data structures are subject to access privileges specified by the selection of rules and the selection of signing groups.
18. The medium of embodiment 17, wherein a private key associated with a wallet address specified in the cryptographic wallet datastructure is stored on the individual HSM partition associated with the cryptographic wallet datastructure.
19. The medium of embodiment 17, wherein the selection of rules includes a selection of allowable hours of operations.
20. The medium of embodiment 17, wherein the selection of rules includes a selection of an address whitelist.
21. The medium of embodiment 17, wherein the selection of rules includes a selection of a minimum allowable amount threshold.
22. The medium of embodiment 17, wherein the selection of rules includes a selection of a maximum allowable amount threshold.
23. The medium of embodiment 17, wherein the selection of signing groups specifies that any authorized signer can provide an approval signature for a signing group.
24. The medium of embodiment 17, wherein the selection of signing groups specifies a combination of authorized signers that can provide an approval signature for a signing group.
25. The medium of embodiment 17, wherein the selection of signing groups includes at least the minimum number of approval signatures number of signing groups.
26. The medium of embodiment 17, wherein the set of asymmetric keys associated with the signing groups comprises one asymmetric public key and a corresponding asymmetric private key.
27. The medium of embodiment 26, wherein the instructions to configure access to the individual HSM partition further comprise instructions to:
   register the asymmetric public key with the individual HSM partition;
   create an asymmetric private key shard for each of the signing groups, wherein access to an asymmetric private key shard associated with a signing group is restricted to the signing group; and
   delete the asymmetric private key;
   wherein the asymmetric keys data comprises the created asymmetric private key shards.
28. The medium of embodiment 27, wherein the asymmetric private key shards are created using Shamir secret sharing cryptographic method.
29. The medium of embodiment 17, wherein the set of asymmetric keys associated with the signing groups comprises an individual asymmetric public key and a corresponding asymmetric private key for each signing group.
30. The medium of embodiment 29, wherein the instructions to configure access to the individual HSM partition further comprise instructions to:
   register each of the individual asymmetric public keys with the individual HSM partition; and
   configure the individual HSM partition to grant access based on a quorum number of signatures that is equal to the selected minimum number of approval signatures;
   wherein access to an asymmetric private key associated with a signing group is restricted to the signing group;
   wherein the asymmetric keys data comprises the generated set of asymmetric keys.
31. The medium of embodiment 17, wherein at least one signing group is associated with a third-party custodian.
32. The medium of embodiment 17, wherein the selection of signing groups specifies authorized signers who should receive staking value.
33. A processor-implemented cryptographic security workflow policy management system, comprising:
   a workflow creation component means, to:
      obtain, via at least one processor, a workflow creation request datastructure associated with a cryptographic wallet datastructure;
      obtain, via at least one processor, a selection of rules for accessing cryptographic assets associated with the cryptographic wallet datastructure;
      obtain, via at least one processor, a selection of a minimum number of approval signatures utilized for accessing cryptographic assets associated with the cryptographic wallet datastructure;
      obtain, via at least one processor, a selection of signing groups, wherein a signing group is associated with an approval signature, wherein a signing group comprises a set of authorized signers;
      generate, via at least one processor, a set of asymmetric keys associated with the signing groups;
      configure, via at least one processor, access to an individual hardware security module (HSM) partition associated with the cryptographic wallet datastructure using the generated set of asymmetric keys; and
      store, via at least one processor, asymmetric keys data for accessing the individual HSM partition in encrypted security vault data structures, wherein the encrypted security vault data structures are subject to access privileges specified by the selection of rules and the selection of signing groups.
34. The system of embodiment 33, wherein a private key associated with a wallet address specified in the cryptographic wallet datastructure is stored on the individual HSM partition associated with the cryptographic wallet datastructure.
35. The system of embodiment 33, wherein the selection of rules includes a selection of allowable hours of operations.
36. The system of embodiment 33, wherein the selection of rules includes a selection of an address whitelist.
37. The system of embodiment 33, wherein the selection of rules includes a selection of a minimum allowable amount threshold.
38. The system of embodiment 33, wherein the selection of rules includes a selection of a maximum allowable amount threshold.
39. The system of embodiment 33, wherein the selection of signing groups specifies that any authorized signer can provide an approval signature for a signing group.
40. The system of embodiment 33, wherein the selection of signing groups specifies a combination of authorized signers that can provide an approval signature for a signing group.
41. The system of embodiment 33, wherein the selection of signing groups includes at least the minimum number of approval signatures number of signing groups.
42. The system of embodiment 33, wherein the set of asymmetric keys associated with the signing groups comprises one asymmetric public key and a corresponding asymmetric private key.
43. The system of embodiment 42, wherein the means to configure access to the individual HSM partition further comprise means to:
   register the asymmetric public key with the individual HSM partition;
   create an asymmetric private key shard for each of the signing groups, wherein access to an asymmetric private key shard associated with a signing group is restricted to the signing group; and
   delete the asymmetric private key;
   wherein the asymmetric keys data comprises the created asymmetric private key shards.
44. The system of embodiment 43, wherein the asymmetric private key shards are created using Shamir secret sharing cryptographic method.
45. The system of embodiment 33, wherein the set of asymmetric keys associated with the signing groups comprises an individual asymmetric public key and a corresponding asymmetric private key for each signing group.
46. The system of embodiment 45, wherein the means to configure access to the individual HSM partition further comprise means to:
   register each of the individual asymmetric public keys with the individual HSM partition; and
   configure the individual HSM partition to grant access based on a quorum number of signatures that is equal to the selected minimum number of approval signatures;
   wherein access to an asymmetric private key associated with a signing group is restricted to the signing group;
   wherein the asymmetric keys data comprises the generated set of asymmetric keys.
47. The system of embodiment 33, wherein at least one signing group is associated with a third-party custodian.
48. The system of embodiment 33, wherein the selection of signing groups specifies authorized signers who should receive staking value.
49. A processor-implemented cryptographic security workflow policy management method, comprising:
   executing processor-implemented workflow creation component instructions to:
      obtain, via at least one processor, a workflow creation request datastructure associated with a cryptographic wallet datastructure;
      obtain, via at least one processor, a selection of rules for accessing cryptographic assets associated with the cryptographic wallet datastructure;
      obtain, via at least one processor, a selection of a minimum number of approval signatures utilized for accessing cryptographic assets associated with the cryptographic wallet datastructure;
      obtain, via at least one processor, a selection of signing groups, wherein a signing group is associated with an approval signature, wherein a signing group comprises a set of authorized signers;
      generate, via at least one processor, a set of asymmetric keys associated with the signing groups;
      configure, via at least one processor, access to an individual hardware security module (HSM) partition associated with the cryptographic wallet datastructure using the generated set of asymmetric keys; and
      store, via at least one processor, asymmetric keys data for accessing the individual HSM partition in encrypted security vault data structures, wherein the encrypted security vault data structures are subject to access privileges specified by the selection of rules and the selection of signing groups.
50. The method of embodiment 49, wherein a private key associated with a wallet address specified in the cryptographic wallet datastructure is stored on the individual HSM partition associated with the cryptographic wallet datastructure.
51. The method of embodiment 49, wherein the selection of rules includes a selection of allowable hours of operations.
52. The method of embodiment 49, wherein the selection of rules includes a selection of an address whitelist.
53. The method of embodiment 49, wherein the selection of rules includes a selection of a minimum allowable amount threshold.
54. The method of embodiment 49, wherein the selection of rules includes a selection of a maximum allowable amount threshold.
55. The method of embodiment 49, wherein the selection of signing groups specifies that any authorized signer can provide an approval signature for a signing group.
56. The method of embodiment 49, wherein the selection of signing groups specifies a combination of authorized signers that can provide an approval signature for a signing group.
57. The method of embodiment 49, wherein the selection of signing groups includes at least the minimum number of approval signatures number of signing groups.
58. The method of embodiment 49, wherein the set of asymmetric keys associated with the signing groups comprises one asymmetric public key and a corresponding asymmetric private key.
59. The method of embodiment 58, wherein the instructions to configure access to the individual HSM partition further comprise instructions to:
   register the asymmetric public key with the individual HSM partition;
   create an asymmetric private key shard for each of the signing groups, wherein access to an asymmetric private key shard associated with a signing group is restricted to the signing group; and
   delete the asymmetric private key;
   wherein the asymmetric keys data comprises the created asymmetric private key shards.
60. The method of embodiment 59, wherein the asymmetric private key shards are created using Shamir secret sharing cryptographic method.
61. The method of embodiment 49, wherein the set of asymmetric keys associated with the signing groups comprises an individual asymmetric public key and a corresponding asymmetric private key for each signing group.
62. The method of embodiment 61, wherein the instructions to configure access to the individual HSM partition further comprise instructions to:
   register each of the individual asymmetric public keys with the individual HSM partition; and
   configure the individual HSM partition to grant access based on a quorum number of signatures that is equal to the selected minimum number of approval signatures;
   wherein access to an asymmetric private key associated with a signing group is restricted to the signing group;
   wherein the asymmetric keys data comprises the generated set of asymmetric keys.
63. The method of embodiment 49, wherein at least one signing group is associated with a third-party custodian.
64. The method of embodiment 49, wherein the selection of signing groups specifies authorized signers who should receive staking value.
117. A cryptographic staking node provisioning apparatus, comprising:
a memory;
a component collection in the memory, including:
   a transaction signing component, and
   a staking node provisioning component;
a processor disposed in communication with the memory, and configured to issue a plurality of processing instructions from the component collection stored in the memory,
   wherein the processor issues instructions from the transaction signing component, stored in the memory, to:
      obtain, via at least one processor, a staking transaction signing request datastructure associated with a cryptographic wallet datastructure;
      determine, via at least one processor, a workflow policy datastructure associated with the cryptographic wallet datastructure that has rules that match transaction parameters specified in the staking transaction signing request datastructure;
      obtain, via at least one processor, a set of transaction approvals from a set of signing groups associated with the determined workflow policy datastructure;
      obtain, via at least one processor, a staking transaction signature associated with the staking transaction signing request datastructure from an individual HSM partition of a first HSM associated with the cryptographic wallet datastructure using the obtained set of transaction approvals;
   wherein the processor issues instructions from the staking node provisioning component, stored in the memory, to:
      determine, via at least one processor, staking node configuration details, wherein the staking node configuration details comprise a node name and a node network;
      obtain, via at least one processor, staking node provisioning details for a staking node from a staking service, wherein the staking node provisioning details include an asymmetric public key of an operator of the staking node;
      generate, via at least one processor, a key registration transaction datastructure, wherein the key registration transaction datastructure comprises the staking transaction signature and the asymmetric public key of the operator of the staking node; and
      obtain, via at least one processor, a key registration transaction signature associated with the key registration transaction datastructure from a second HSM.
118. The apparatus of embodiment 117, further, comprising:
   the processor issues instructions from the transaction signing component, stored in the memory, to:
      decrypt an asymmetric private key shard of each signing group that provided a transaction approval; and
      construct an asymmetric private key from the decrypted asymmetric private key shards.
119. The apparatus of embodiment 118, wherein the asymmetric private key is constructed using Shamir secret sharing cryptographic method.
120. The apparatus of embodiment 117, further, comprising:
   the processor issues instructions from the transaction signing component, stored in the memory, to:
      decrypt an asymmetric private key of each signing group that provided a transaction approval;
      obtain a quorum token associated with the staking transaction signing request datastructure; and
      sign the quorum token using the decrypted asymmetric private keys.
121. The apparatus of embodiment 117, wherein the staking service is an internal service.
122. The apparatus of embodiment 117, wherein the staking service is a third-party service.
123. The apparatus of embodiment 117, wherein the second HSM is an air-gapped cold HSM.
124. A processor-readable cryptographic staking node provisioning non-transient physical medium storing processor-executable components, the components, comprising:
a component collection stored in the medium, including:
   a transaction signing component, and
   a staking node provisioning component;
   wherein the transaction signing component, stored in the medium, includes processor-issuable instructions to:
      obtain, via at least one processor, a staking transaction signing request datastructure associated with a cryptographic wallet datastructure;
      determine, via at least one processor, a workflow policy datastructure associated with the cryptographic wallet datastructure that has rules that match transaction parameters specified in the staking transaction signing request datastructure;
      obtain, via at least one processor, a set of transaction approvals from a set of signing groups associated with the determined workflow policy datastructure;
      obtain, via at least one processor, a staking transaction signature associated with the staking transaction signing request datastructure from an individual HSM partition of a first HSM associated with the cryptographic wallet datastructure using the obtained set of transaction approvals;
   wherein the staking node provisioning component, stored in the medium, includes processor-issuable instructions to:
      determine, via at least one processor, staking node configuration details, wherein the staking node configuration details comprise a node name and a node network;
      obtain, via at least one processor, staking node provisioning details for a staking node from a staking service, wherein the staking node provisioning details include an asymmetric public key of an operator of the staking node;
      generate, via at least one processor, a key registration transaction datastructure, wherein the key registration transaction datastructure comprises the staking transaction signature and the asymmetric public key of the operator of the staking node; and
      obtain, via at least one processor, a key registration transaction signature associated with the key registration transaction datastructure from a second HSM.
125. The medium of embodiment 124, further, comprising:
   the transaction signing component, stored in the medium, includes processor-issuable instructions to:
      decrypt an asymmetric private key shard of each signing group that provided a transaction approval; and
      construct an asymmetric private key from the decrypted asymmetric private key shards.
126. The medium of embodiment 125, wherein the asymmetric private key is constructed using Shamir secret sharing cryptographic method.
127. The medium of embodiment 124, further, comprising:
   the transaction signing component, stored in the medium, includes processor-issuable instructions to:
      decrypt an asymmetric private key of each signing group that provided a transaction approval;
      obtain a quorum token associated with the staking transaction signing request datastructure; and
      sign the quorum token using the decrypted asymmetric private keys.
128. The medium of embodiment 124, wherein the staking service is an internal service.
129. The medium of embodiment 124, wherein the staking service is a third-party service.
130. The medium of embodiment 124, wherein the second HSM is an air-gapped cold HSM.
131. A processor-implemented cryptographic staking node provisioning system, comprising:
   a transaction signing component means, to:
      obtain, via at least one processor, a staking transaction signing request datastructure associated with a cryptographic wallet datastructure;
      determine, via at least one processor, a workflow policy datastructure associated with the cryptographic wallet datastructure that has rules that match transaction parameters specified in the staking transaction signing request datastructure;
      obtain, via at least one processor, a set of transaction approvals from a set of signing groups associated with the determined workflow policy datastructure;
      obtain, via at least one processor, a staking transaction signature associated with the staking transaction signing request datastructure from an individual HSM partition of a first HSM associated with the cryptographic wallet datastructure using the obtained set of transaction approvals;
   a staking node provisioning component means, to:
      determine, via at least one processor, staking node configuration details, wherein the staking node configuration details comprise a node name and a node network;
      obtain, via at least one processor, staking node provisioning details for a staking node from a staking service, wherein the staking node provisioning details include an asymmetric public key of an operator of the staking node;
      generate, via at least one processor, a key registration transaction datastructure, wherein the key registration transaction datastructure comprises the staking transaction signature and the asymmetric public key of the operator of the staking node; and
      obtain, via at least one processor, a key registration transaction signature associated with the key registration transaction datastructure from a second HSM.
132. The system of embodiment 131, further, comprising:
   the transaction signing component means, to:
      decrypt an asymmetric private key shard of each signing group that provided a transaction approval; and
      construct an asymmetric private key from the decrypted asymmetric private key shards.
133. The system of embodiment 132, wherein the asymmetric private key is constructed using Shamir secret sharing cryptographic method.
134. The system of embodiment 131, further, comprising:
   the transaction signing component means, to:
      decrypt an asymmetric private key of each signing group that provided a transaction approval;
      obtain a quorum token associated with the staking transaction signing request datastructure; and
      sign the quorum token using the decrypted asymmetric private keys.
135. The system of embodiment 131, wherein the staking service is an internal service.
136. The system of embodiment 131, wherein the staking service is a third-party service.
137. The system of embodiment 131, wherein the second HSM is an air-gapped cold HSM.
138. A processor-implemented cryptographic staking node provisioning method, comprising:
   executing processor-implemented transaction signing component instructions to:
      obtain, via at least one processor, a staking transaction signing request datastructure associated with a cryptographic wallet datastructure;
      determine, via at least one processor, a workflow policy datastructure associated with the cryptographic wallet datastructure that has rules that match transaction parameters specified in the staking transaction signing request datastructure;
      obtain, via at least one processor, a set of transaction approvals from a set of signing groups associated with the determined workflow policy datastructure;
      obtain, via at least one processor, a staking transaction signature associated with the staking transaction signing request datastructure from an individual HSM partition of a first HSM associated with the cryptographic wallet datastructure using the obtained set of transaction approvals;
   executing processor-implemented staking node provisioning component instructions to:
      determine, via at least one processor, staking node configuration details, wherein the staking node configuration details comprise a node name and a node network;
      obtain, via at least one processor, staking node provisioning details for a staking node from a staking service, wherein the staking node provisioning details include an asymmetric public key of an operator of the staking node;
      generate, via at least one processor, a key registration transaction datastructure, wherein the key registration transaction datastructure comprises the staking transaction signature and the asymmetric public key of the operator of the staking node; and
      obtain, via at least one processor, a key registration transaction signature associated with the key registration transaction datastructure from a second HSM.
139. The method of embodiment 138, further, comprising:
   executing processor-implemented transaction signing component instructions to:
      decrypt an asymmetric private key shard of each signing group that provided a transaction approval; and
      construct an asymmetric private key from the decrypted asymmetric private key shards.
140. The method of embodiment 139, wherein the asymmetric private key is constructed using Shamir secret sharing cryptographic method.
141. The method of embodiment 138, further, comprising:
   executing processor-implemented transaction signing component instructions to:
      decrypt an asymmetric private key of each signing group that provided a transaction approval;
      obtain a quorum token associated with the staking transaction signing request datastructure; and
      sign the quorum token using the decrypted asymmetric private keys.
142. The method of embodiment 138, wherein the staking service is an internal service.
143. The method of embodiment 138, wherein the staking service is a third-party service.
144. The method of embodiment 138, wherein the second HSM is an air-gapped cold HSM.
201. A cryptographic security workflow sharding management apparatus, comprising:
a memory;
a component collection in the memory;
a processor disposed in communication with the memory, and configured to issue a plurality of processing instructions from the component collection stored in the memory, to:
   obtain a selection of cryptographic assets identifier datastructures;
   obtain a selection of a cryptographic wallet identifier datastructures;
   obtain a selection of roles for a selection of users;
   obtain a selection of conditions for access to the selected cryptographic assets and cryptographic wallet referenced by the identifier datastructures, wherein the conditions include roles for the selection of users;
   generate an individual HSM partition to store cryptographic private keys identified by the identifier datastructures and generate asymmetric key shards for accessing the individual HSM partition;
   store the generated asymmetric keys in a security vault data structures, wherein the security vault datastructure is subject to access privilege workflow policies generated by the selection of conditions for access.

In order to address various issues and advance the art, the entirety of this application for Security Secret Interface and Token Wrap Structure Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Further and to the extent any financial and/or investment examples are included, such examples are for illustrative purpose(s) only, and are not, nor should they be interpreted, as investment advice. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower”, “upper”, “horizontal”, “vertical”, “above”, “below”, “up”, “down”, “top” and “bottom” as well as derivative thereof (e.g., “horizontally”, “downwardly”, “upwardly”, etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached”, “affixed”, “connected”, “coupled”, “interconnected”, and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SSITWS individual and/or enterprise user, database configuration and/or relational model, data type, data transmission and/or network framework, syntax structure, and/or the like, various embodiments of the SSITWS, may be implemented that allow a great deal of flexibility and customization. For example, aspects of the SSITWS may be adapted for information technology security infrastructure. While various embodiments and discussions of the SSITWS have included security encryption and management, however, it is to be understood that the embodiments described herein may be readily configured and/or customized for a wide variety of other applications and/or implementations.

What is claimed is:

1. A cryptographic security workflow policy management apparatus, comprising:
a memory;
a component collection in the memory, including:
a workflow creation component;
a processor disposed in communication with the memory, and configured to issue a plurality of processing instructions from the component collection stored in the memory,
wherein the processor issues instructions from the workflow creation component, stored in the memory, to:
obtain, via at least one processor, a workflow creation request datastructure associated with a cryptographic wallet datastructure;
obtain, via at least one processor, a selection of rules for accessing cryptographic assets associated with the cryptographic wallet datastructure;
obtain, via at least one processor, a selection of a minimum number of approval signatures utilized for accessing cryptographic assets associated with the cryptographic wallet datastructure;
obtain, via at least one processor, a selection of signing groups, wherein a signing group is associated with an approval signature, wherein a signing group comprises a set of authorized signers;
generate, via at least one processor, a set of asymmetric keys associated with the signing groups;
configure, via at least one processor, access to an individual hardware security module (HSM) partition associated with the cryptographic wallet datastructure using the generated set of asymmetric keys; and
store, via at least one processor, asymmetric keys data for accessing the individual HSM partition in encrypted security vault data structures, wherein the encrypted security vault data structures are subject to access privileges specified by the selection of rules and the selection of signing groups.

2. The apparatus of claim 1, wherein a private key associated with a wallet address specified in the cryptographic wallet datastructure is stored on the individual HSM partition associated with the cryptographic wallet datastructure.

3. The apparatus of claim 1, wherein the selection of rules includes a selection of allowable hours of operations.

4. The apparatus of claim 1, wherein the selection of rules includes a selection of an address whitelist.

5. The apparatus of claim 1, wherein the selection of rules includes a selection of a minimum allowable amount threshold.

6. The apparatus of claim 1, wherein the selection of rules includes a selection of a maximum allowable amount threshold.

7. The apparatus of claim 1, wherein the selection of signing groups specifies that any authorized signer can provide an approval signature for a signing group.

8. The apparatus of claim 1, wherein the selection of signing groups specifies a combination of authorized signers that can provide an approval signature for a signing group.

9. The apparatus of claim 1, wherein the selection of signing groups includes at least the minimum number of approval signatures number of signing groups.

10. The apparatus of claim 1, wherein the set of asymmetric keys associated with the signing groups comprises one asymmetric public key and a corresponding asymmetric private key.

11. The apparatus of claim 10, wherein the instructions to configure access to the individual HSM partition further comprise instructions to:
register the asymmetric public key with the individual HSM partition;
create an asymmetric private key shard for each of the signing groups, wherein access to an asymmetric private key shard associated with a signing group is restricted to the signing group; and
delete the asymmetric private key;
wherein the asymmetric keys data comprises the created asymmetric private key shards.

12. The apparatus of claim 11, wherein the asymmetric private key shards are created using Shamir secret sharing cryptographic method.

13. The apparatus of claim 1, wherein the set of asymmetric keys associated with the signing groups comprises an individual asymmetric public key and a corresponding asymmetric private key for each signing group.

14. The apparatus of claim 13, wherein the instructions to configure access to the individual HSM partition further comprise instructions to:
register each of the individual asymmetric public keys with the individual HSM partition; and
configure the individual HSM partition to grant access based on a quorum number of signatures that is equal to the selected minimum number of approval signatures;
wherein access to an asymmetric private key associated with a signing group is restricted to the signing group;
wherein the asymmetric keys data comprises the generated set of asymmetric keys.

15. The apparatus of claim 1, wherein at least one signing group is associated with a third-party custodian.

16. The apparatus of claim 1, wherein the selection of signing groups specifies authorized signers who should receive staking value.

17. A cryptographic staking node provisioning apparatus, comprising:
a memory;
a component collection in the memory, including:
a transaction signing component, and
a staking node provisioning component;
a processor disposed in communication with the memory, and configured to issue a plurality of processing instructions from the component collection stored in the memory,
wherein the processor issues instructions from the transaction signing component, stored in the memory, to:
obtain, via at least one processor, a staking transaction signing request datastructure associated with a cryptographic wallet datastructure;
determine, via at least one processor, a workflow policy datastructure associated with the cryptographic wallet datastructure that has rules that match transaction parameters specified in the staking transaction signing request datastructure;
obtain, via at least one processor, a set of transaction approvals from a set of signing groups associated with the determined workflow policy datastructure;
obtain, via at least one processor, a staking transaction signature associated with the staking transaction signing request datastructure from an individual HSM partition of a first HSM associated with the cryptographic wallet datastructure using the obtained set of transaction approvals;
wherein the processor issues instructions from the staking node provisioning component, stored in the memory, to:
determine, via at least one processor, staking node configuration details, wherein the staking node configuration details comprise a node name and a node network;
obtain, via at least one processor, staking node provisioning details for a staking node from a staking service, wherein the staking node provisioning details include an asymmetric public key of an operator of the staking node;
generate, via at least one processor, a key registration transaction datastructure, wherein the key registration transaction datastructure comprises the staking transaction signature and the asymmetric public key of the operator of the staking node; and
obtain, via at least one processor, a key registration transaction signature associated with the key registration transaction datastructure from a second HSM.

18. The apparatus of claim 17, further, comprising:
the processor issues instructions from the transaction signing component, stored in the memory, to:
decrypt an asymmetric private key shard of each signing group that provided a transaction approval; and
construct an asymmetric private key from the decrypted asymmetric private key shards.

19. The apparatus of claim 18, wherein the asymmetric private key is constructed using Shamir secret sharing cryptographic method.

20. The apparatus of claim 17, further, comprising:
the processor issues instructions from the transaction signing component, stored in the memory, to:
decrypt an asymmetric private key of each signing group that provided a transaction approval;
obtain a quorum token associated with the staking transaction signing request datastructure; and
sign the quorum token using the decrypted asymmetric private keys.

21. The apparatus of claim 17, wherein the staking service is an internal service.

22. The apparatus of claim 17, wherein the staking service is a third-party service.

23. The apparatus of claim 17, wherein the second HSM is an air-gapped cold HSM.

24. A processor-readable cryptographic security workflow policy management non-transient physical medium storing processor-executable components, the components, comprising:
a component collection stored in the medium, including:
a workflow creation component;
wherein the workflow creation component, stored in the medium, includes processor-issuable instructions to:
obtain, via at least one processor, a workflow creation request datastructure associated with a cryptographic wallet datastructure;
obtain, via at least one processor, a selection of rules for accessing cryptographic assets associated with the cryptographic wallet datastructure;
obtain, via at least one processor, a selection of a minimum number of approval signatures utilized for accessing cryptographic assets associated with the cryptographic wallet datastructure;
obtain, via at least one processor, a selection of signing groups, wherein a signing group is associated with an approval signature, wherein a signing group comprises a set of authorized signers;
generate, via at least one processor, a set of asymmetric keys associated with the signing groups;
configure, via at least one processor, access to an individual hardware security module (HSM) partition associated with the cryptographic wallet datastructure using the generated set of asymmetric keys; and
store, via at least one processor, asymmetric keys data for accessing the individual HSM partition in encrypted security vault data structures, wherein the encrypted security vault data structures are subject to access privileges specified by the selection of rules and the selection of signing groups.

25. A processor-implemented cryptographic security workflow policy management system, comprising:
a workflow creation component means, to:
obtain, via at least one processor, a workflow creation request datastructure associated with a cryptographic wallet datastructure;
obtain, via at least one processor, a selection of rules for accessing cryptographic assets associated with the cryptographic wallet datastructure;
obtain, via at least one processor, a selection of a minimum number of approval signatures utilized for accessing cryptographic assets associated with the cryptographic wallet datastructure;
obtain, via at least one processor, a selection of signing groups, wherein a signing group is associated with an approval signature, wherein a signing group comprises a set of authorized signers;
generate, via at least one processor, a set of asymmetric keys associated with the signing groups;
configure, via at least one processor, access to an individual hardware security module (HSM) partition associated with the cryptographic wallet datastructure using the generated set of asymmetric keys; and
store, via at least one processor, asymmetric keys data for accessing the individual HSM partition in encrypted security vault data structures, wherein the encrypted security vault data structures are subject to access privileges specified by the selection of rules and the selection of signing groups.

26. A processor-implemented cryptographic security workflow policy management method, comprising:
executing processor-implemented workflow creation component instructions to:
obtain, via at least one processor, a workflow creation request datastructure associated with a cryptographic wallet datastructure;
obtain, via at least one processor, a selection of rules for accessing cryptographic assets associated with the cryptographic wallet datastructure;
obtain, via at least one processor, a selection of a minimum number of approval signatures utilized for accessing cryptographic assets associated with the cryptographic wallet datastructure;
obtain, via at least one processor, a selection of signing groups, wherein a signing group is associated with an approval signature, wherein a signing group comprises a set of authorized signers;
generate, via at least one processor, a set of asymmetric keys associated with the signing groups;
configure, via at least one processor, access to an individual hardware security module (HSM) partition associated with the cryptographic wallet datastructure using the generated set of asymmetric keys; and
store, via at least one processor, asymmetric keys data for accessing the individual HSM partition in encrypted security vault data structures, wherein the encrypted security vault data structures are subject to access privileges specified by the selection of rules and the selection of signing groups.

27. A processor-readable cryptographic staking node provisioning non-transient physical medium storing processor-executable components, the components, comprising:
a component collection stored in the medium, including:
a transaction signing component, and
a staking node provisioning component;
wherein the transaction signing component, stored in the medium, includes processor-issuable instructions to:
obtain, via at least one processor, a staking transaction signing request datastructure associated with a cryptographic wallet datastructure;
determine, via at least one processor, a workflow policy datastructure associated with the cryptographic wallet datastructure that has rules that match transaction parameters specified in the staking transaction signing request datastructure;
obtain, via at least one processor, a set of transaction approvals from a set of signing groups associated with the determined workflow policy datastructure;
obtain, via at least one processor, a staking transaction signature associated with the staking transaction signing request datastructure from an individual HSM partition of a first HSM associated with the cryptographic wallet datastructure using the obtained set of transaction approvals;
wherein the staking node provisioning component, stored in the medium, includes processor-issuable instructions to:
determine, via at least one processor, staking node configuration details, wherein the staking node configuration details comprise a node name and a node network;
obtain, via at least one processor, staking node provisioning details for a staking node from a staking service, wherein the staking node provisioning details include an asymmetric public key of an operator of the staking node;
generate, via at least one processor, a key registration transaction datastructure, wherein the key registration transaction datastructure comprises the staking transaction signature and the asymmetric public key of the operator of the staking node; and
obtain, via at least one processor, a key registration transaction signature associated with the key registration transaction datastructure from a second HSM.

28. A processor-implemented cryptographic staking node provisioning system, comprising:
a transaction signing component means, to:
obtain, via at least one processor, a staking transaction signing request datastructure associated with a cryptographic wallet datastructure;
determine, via at least one processor, a workflow policy datastructure associated with the cryptographic wallet datastructure that has rules that match transaction parameters specified in the staking transaction signing request datastructure;
obtain, via at least one processor, a set of transaction approvals from a set of signing groups associated with the determined workflow policy datastructure;
obtain, via at least one processor, a staking transaction signature associated with the staking transaction signing request datastructure from an individual HSM partition of a first HSM associated with the cryptographic wallet datastructure using the obtained set of transaction approvals;
a staking node provisioning component means, to:
determine, via at least one processor, staking node configuration details, wherein the staking node configuration details comprise a node name and a node network;
obtain, via at least one processor, staking node provisioning details for a staking node from a staking service, wherein the staking node provisioning details include an asymmetric public key of an operator of the staking node;
generate, via at least one processor, a key registration transaction datastructure, wherein the key registration transaction datastructure comprises the staking transaction signature and the asymmetric public key of the operator of the staking node; and
obtain, via at least one processor, a key registration transaction signature associated with the key registration transaction datastructure from a second HSM.

29. A processor-implemented cryptographic staking node provisioning method, comprising:
executing processor-implemented transaction signing component instructions to:
obtain, via at least one processor, a staking transaction signing request datastructure associated with a cryptographic wallet datastructure;
determine, via at least one processor, a workflow policy datastructure associated with the cryptographic wallet datastructure that has rules that match transaction parameters specified in the staking transaction signing request datastructure;
obtain, via at least one processor, a set of transaction approvals from a set of signing groups associated with the determined workflow policy datastructure;
obtain, via at least one processor, a staking transaction signature associated with the staking transaction signing request datastructure from an individual HSM partition of a first HSM associated with the cryptographic wallet datastructure using the obtained set of transaction approvals;
executing processor-implemented staking node provisioning component instructions to:
determine, via at least one processor, staking node configuration details, wherein the staking node configuration details comprise a node name and a node network;
obtain, via at least one processor, staking node provisioning details for a staking node from a staking service, wherein the staking node provisioning details include an asymmetric public key of an operator of the staking node;
generate, via at least one processor, a key registration transaction datastructure, wherein the key registration transaction datastructure comprises the staking transaction signature and the asymmetric public key of the operator of the staking node; and
obtain, via at least one processor, a key registration transaction signature associated with the key registration transaction datastructure from a second HSM.
